(19) United States
(12) Patent Application Publication
(10) Pub. No.: US 2009/0216911 A1
(43) Pub. Date: Aug. 27, 2009

(54) Method and system for intuitive coding to enter text expansions

(76) Inventor: Larry Long, Fayetteville, AR (US)

Correspondence Address: HENRY LAW FIRM, P.O. BOX 8850, FAYETTEVILLE, AR, 72703, US

(21) Appl. No.: 12/070,804

(22) Filed: Feb. 21, 2008

(51) Int. Cl. G06F 3/00; G06F 17/30

(52) U.S. Cl. 710/2; 707/3; 707/E17.108

(57) ABSTRACT

The present invention relates generally to a keyboarding productivity system for expanding a number of characters entered into a computing device. The present invention expands a first predefined set of characters to a second predefined set of characters, an expansion associated with a matching code. A user of the present invention inputs a user entry into a program that accepts user input. The present invention then compares the user entry to at least one code to identify a matching code that matches the user entry. The present invention then expands the user entry to the expansion associated with the matching code. If a matching code is not found, the present invention allows the user entry to remain as input.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### RESERVATION OF RIGHTS

A portion of the disclosure of this patent document contains material which is subject to intellectual property rights such as but not limited to copyright, trademark, and/or trade dress protection. The owner has no objection to the facsimile reproduction by anyone of the patent document or the patent disclosure as it appears in the Patent and Trademark Office patent files or records but otherwise reserves all rights whatsoever.

### BACKGROUND OF THE INVENTION

1. Field of the Invention

The present invention relates to a method and system that enables keyboarders to enter text to a computer or handheld electronic device with significantly fewer keystrokes by using intuitive codes to expand words, phrases, and other text information within applications that accept text input.

2. Background Information

Coding as a means to abbreviate words and phrases has been around for a long time in many forms and for many applications. The first widely accepted coding scheme used to represent words and phrases was employed by telegraphers who used the Morse code of dashes and dots to represent characters. Shorthand codes included “1” (wait a minute), “OS” (on station), and “DLY” (delivery). For decades stenographers have used shorthand as a form of speed writing. This symbolic writing method requires the stenographer to learn symbols for thousands of words and phrases. Today, people use coding when they compose text messages on PCs, cell phones, and PDAs, such codes including CU (See you), BBL (Be back later), and W8 (Wait).

After more than half a century of computing, the standard mode of text entry for the general user of a computing device remains keying each and every character in a word. Outside of speech recognition software and some commercial word expander programs, relatively little has transpired to change this notion. The state of the art of speech recognition is quite high; nevertheless, keyboarding remains the overwhelming choice for entering text to a computing device. Commercial word expander programs are designed primarily for use by a small community of professional transcriptionists (see known art) who might be willing to develop the necessary skills to use them effectively. The present invention was born of a need by general users for whom PCs and handheld electronic devices have evolved to become companions that inform, entertain, teach, complement memory, and aid in so many forms of communication from text messages to books. The general user needs a way to be more productive when interacting with these devices.

3. Description of Known Art

A number of commercial “text expander” products for personal computers and/or handheld devices employ at least one or all of these approaches to expedite text entry via a keyboard: two-column table, word completion, or jump ahead. T9, called predictive text, represents the prior art for text entry on handheld communications devices. Also, several coding systems have been proposed that are designed to help people create and remember entries in two-column table entries.

### The Two-Column Table

The foundation of any commercial text expander software package is the two-column table that might be referenced by a variety of names, including glossary, dictionary, vocabulary, word database, and so on. One column contains a user-defined code and the other the expansion or text to be entered to the document when a code is entered. The user has only to enter the code and hit one or more predefined delimiters, perhaps a space, to delete the code and replace it instantaneously with the associated text. The two-column approach placed a heavy emphasis on memorization. To use the two-column table in tandem with expander software, a user would first create the table, including the codes for a particular expansion and then commit the table to memory. Users do their best to assign codes that are easily remembered, but with thousands of possible words and phrases, memorization plays a key role in effective use of text expander software. Because it is unrealistic to expect the general user to create and memorize hundreds, even thousands, of codes, such programs are used primarily by professional transcriptionists. In practice, the general user may find it a challenge to recall more than 100 codes on-the-fly during keyboarding. This, in effect, caps the keyboarding productivity ceiling for the general user at around 10%.

U.S. Pat. No. 5,761,689 Method and System for Entering Text in Computer Equipment discloses a method and word processing system for automatically replacing one or more characters of text entered by a user in a word processing document with the corresponding plain text, formatted text, or other object. Users of Microsoft Office know the embodiment of '689 as its Autocorrect feature, the most widely known and used two-column table. The '689 patent discloses a method for automatically replacing an entry made by a user in a document with a replacement. Using the autocorrect function of the '689 patent, the user can automatically correct commonly misspelled words, and automatically expand relatively short groups of characters to longer words, paragraphs, or graphic objects.

### Word Completion

The word completion application can be found in web browsers, spreadsheets, cell phones, PDAs, and other text-entry situations. When the keyboarder begins entering text, the word completion facility either completes the entry automatically or gives the user a list of word/phrase choices to complete the expansion. The AutoComplete feature in Microsoft Word detects when you enter four letters of a day of the week (e.g., wedn) and then gives the user the option to expand the entry to the full word (e.g., Wednesday).

Systems based on word completion have noteworthy limitations. Such a system demands that the keyboarder determine whether it is better to continue keying and shorten the length of the list of options or to manually scan the currently available “best choices” in hope that the list contains the desired word. This exercise occurs after each keystroke. A large percentage of common English words have variations that require the user to enter most of the letters before achieving uniqueness. For example, if you wish to insert considerably you still have considered, considers, considering, and considerable up through consider. Large numbers of words have prefixes, so you would need to enter the prefix (inter, auto, pre, pro, and so on) and at least three letters. Once the general keyboarder has entered half or more of the letters, assessed the options in several lists, made a selection, and returned to his or her train of thought, the user has invested significant time in the word completion activity. Innovators continue to create technologies that can more accurately predict what words are presented for selection as disclosed in U.S. Pat. No. 5,805,911 Word Prediction System and U.S. Pat. No. 6,377,965 Automatic Word Completion System for Partially Entered Data.

### Jump Ahead

One system that addresses the memorization issue is embodied in a commercial software product and disclosed in U.S. Pat. No. 5,623,406, Method and System for Entering Text in Computer Equipment. U.S. Pat. No. 5,623,406 (“the '406 patent”) issued to Ichbiah on Apr. 22, 1997 teaches a system for entry of text into a computer. The system taught by the '406 patent uses a current glossary, which may be custom generated to reflect common phrases and words pertaining to any specific subject matter, as a source for retrieving words and phrases from abbreviations. Text entry is input into the system taught by the '406 patent through the entry of word abbreviations, phrase abbreviations and text entries. The system taught by the '406 patent uses non-fixed abbreviations for words and phrases. A word abbreviation taught by the '406 patent starts with the initial of the word and includes a subset of its other letters. A phrase abbreviation taught by the '406 patent starts with the initials of its first word, or two words, and includes a subset of the initials of its other words. In addition, the '406 patent teaches that words and phrases satisfying a specific abbreviation are displayed in advisory tables. A desired word or phrase may be selected using an expansion command of the '406 patent. The expanded term is then entered into the system taught by the '406 patent and thereby permits entry of lengthy phrases and words with minimal text entry. Finally, the system taught by the '406 patent proposes phrases that are likely continuations to the last entered words, allowing fast selection and input of such continuations.

Jump ahead offers a boost in keyboarding productivity for professional transcriptionists but, in practice, it has noteworthy challenges for the general user. Selecting and entering the letters of word in their sequence during on-the-fly keyboarding until a match is found can pose a challenge for the general user.

In order to limit possible conflicts for coding options, the jump-ahead system uses a current glossary of common phrases and words pertaining to specific subject matter at any given time as the source for retrieving words and phrases by entering abbreviations. For instance, in a law firm there may be multiple lawyers who specialize in patent law, family law, and corporate law. Each group of lawyers might have their own glossary, or series of glossaries, which contain words and phrases commonly referenced in their specialty.

Jump ahead extracts a high level of mental effort, like word completion, because the user must choose among available glossaries as needed and continually do a visual examination of a new list of words for each character entered.

### Predictive Text

Most cell phones enable text entry via a 12-key keypad, which employs multi-tap technology. When in multi-tap mode, users continue to tap a particular multifunction key until the desired character is displayed on the screen. Entering the word “first” via multi-tap requires 14 keystrokes: “f” on the 3-DEF key, “i” on the 4-GHI key, and so on. T9 provides a more efficient alternative to multi-tap key entry.

T9, which stands for Text on 9 keys, is also called Predictive Text, Dictionary, and T9 Word. With T9 installed on over 2 billion mobile phones, the method of U.S. Pat. No. 5,818,437 is well known in the art. With T9, the user taps only one key at a time for each letter. For each tap, T9 enters one of the three or four letters on a key and the software assesses all combinations of letters entered and then predicts and displays the most likely word. For example, if you wish to insert “biking” it would be 2-4-5-4-6-4. T9 chooses “ailing” as the most likely entry, but there are other options. Since “ailing” is not what you want, you must scroll through the other options (bikini, biking, biling) and select the third option, “biking.” When used in tandem with T9, the present invention offers the potential to significantly increase throughput on handheld devices with 12-key keypads.

### Coding Systems For the Two-Column Table

The Achilles heel of any two-column table approach to text expansion is that there is no standardized methodology for creating easily remembered codes for recall while using text expander software. Several coding systems have been disclosed in U.S. Pat. No. 4,893,238 Text Processing Device for Stenographic Typing, U.S. Pat. No. 4,760,528 Method for Entering Text Using Abbreviated Word Forms, U.S. Pat. No. 4,969,097 Method of Rapid Entering of Text into Computer Equipment, and the ABCZ Typing Abbreviation System© 1989-2002.

U.S. Pat. No. 4,893,238 (“the '238 patent”) issued to Venema teaches a text processing device for stenographic typing comprises an alphanumerical keyboard, a translation device, a read/write memory and a display device. Given, frequently occurring words can be entered into the device in abbreviated form as taught by the '238 patent. Words of a main set are entered by way of a sequence of two or more key strokes. At least the first two thereof each define a word part to be separately pronounced, for example, in that they constitute the first letters of respective syllables. The full word corresponding to an abbreviated word is formed by the translation device taught by the '238 patent in that at least one missing letter is inserted each time between two successively entered letters. Furthermore, the '238 patent teaches the formation of a multitude of word endings automatically. The '238 patent also teaches a set of standard abbreviations can be supplemented by special abbreviations (for example, names of persons, authorities or complex chemical formulas) which can be separately entered by means of a separate mechanism.

The '238 patent teaches that the codes for the '238 patent can have as many letters as syllables. This is a drawback of the '238 patent because of the varying lengths of the codes. When the codes for root words are of varying lengths, any standardized attempt to form unique codes for variations will result in conflicts with codes that are one character longer. The '238 patent has a code for considerable, but not for consider or any of the other seven variations of consider. Also, a drawback of the '238 patent is that the method limits the range of codes available for this coding system. Therefore, the focus is on codes and expansions of frequently occurring words.

U.S. Pat. No. 4,760,528 (“the '528 patent”) issued to Levin on Jul. 26, 1988 teaches an abbreviated text entering system that provides a plurality of files each of which includes a full text word and a corresponding abbreviated word. In each of the files taught by the '528 patent, the abbreviated word is formed using a different rule, and at least one file is provided for words of five or more characters, a different file is provided for words including one of a plurality of predefined prefixes, a further file is provided for words including one or more predefined suffixes, and another file is provided for words which include one of a plurality of predefined prefixes and one of a plurality of predefined suffixes. The '528 patent teaches that entered text is compared with the abbreviated word forms, and on a match, that full text word corresponding to the matched abbreviated text is stored in lieu of the entered text.

U.S. Pat. No. 4,969,097 (“the '097 patent”) issued to Levin on Nov. 6, 1990 teaches a method and apparatus for rapidly entering text into a computing machine. An operator of the invention disclosed in the '097 patent may enter text in abbreviated form using several simple rules to predict which abbreviated word forms will be correctly recognized. In the event of conflicts (where one abbreviated word matches more than one full text work), the operator of the invention taught by the '097 patent selects the preferred resolution either on an individual or global basis.

Knowing which code to use for a particular word can be a drawback. Codes for prefix/suffix words are formed by adding a single character at the beginning or end of the code. In practice, the method disclosed in the '528 patent and the '097 patent may not provide a level of code uniqueness required for enhanced keyboarding activity. For instance, an example in the patent documentation shows the code for corporations to be cons and demonstrates the methods inherent limitations. First, cons is a plural noun but most significantly, cons would be the code for scores of other common words, including columns, concerns, conditions, comparisons, connections, collections, convictions, correlations, and many more. The '528 patent method includes the use of “prefixes” and “suffixes,” but not in a traditional sense. For example, the con in condition is considered a prefix and the tion is deemed a suffix. The drawbacks of the '528 patent and the '097 patent mirror those of the '238 patent thereby limiting practical application for the general user.

The ABCZ Typing Abbreviation System© 1989-2007 by Jon Knowles, a coding scheme developed for medical transcriptionist, offers medical databases (codes and expansions) that are compatible with popular commercial word expander programs. The basic coding scheme is abcyz, where abc is the first three letters of the word and yz is the last two. The present invention offers a more straightforward method of coding than using the first three letters and the last one and/or two to determine a word/phrase to be inserted in a document. The ABCZ system invites the user to either memorize the code or to stop and think about the spelling of the word. Furthermore, because there are so many duplicate words that begin with the same three characters, the user must continually scan the software's advisory list for the desired word or phrase. Another drawback is the system's lack of an intuitive method for handling variations on a word (for example, character versus characterizes versus characterization). The use of ABCZ gives medical transcriptionist a leg up on coding words and the system makes it easier to memorize the abbreviation codes. However, in practice, the numerous exceptions demand that transcriptionists still commit a significant number of codes to memory. For example, consider the 11 forms of the word character in Table 1.

TABLE 1

| ABCZ code | Word |
|---|---|
| char | character |
| chasd | characters |
| chac | characteristic |
| NA | characteristics |
| chayb | characteristically |
| chaed | characterize |
| chasc | characterizes |
| chadc | characterized |
| chagc | characterizing |
| chanb | characterization |
| NA | characterizations |

Notice that the ABCZ rule is applied to only two of the eleven forms. An arbitrary letter was appended to seven of the forms to avoid conflicts with variations of other “cha” words, such as champion and challenge. Because the appended letter is inconsistent (either a “b,” “c,” or “d”), the user may need to commit these and thousands of other codes to memory to recall them while keyboarding on-the-fly. Note also that two relatively common variations of character, characteristics and characterizations, are not included in the database. This comparative example is representative. In contrast, the present invention enables thousands of words, including all forms of the word character, to be entered easily via codes that are intuitively extracted from the words' phonetic units and by applying simple, straightforward rules to enter variations of a word.

The known art for creating codes for association with expansions in two-column tables have been employed in practice mostly within the world of professional transcriptionists. Moreover, the onus is on the user to create the two-column table and its code/expansion entries. Regarding coding systems, the known art relies heavily on the user's knowledge of grammar (syllables) and character sequencing within a word to enter a code (an abbreviation) to be expanded. In practice, current approaches present too great of a personal challenge for the general user to learn and to employ on-the-fly while keyboarding.

Thus, the need exists to provide the general user of computer devices, over 99% the user population, with an intuitive and comprehensive coding system that is easily learned and used for text entry to any computing device equipped with the appropriate support software. The present invention includes a comprehensive two-column table of thousands of common words and phrases and provides the capability for customization for the peculiar needs of an individual or the peculiar needs of users operating within a particular computing environment.

### SUMMARY OF THE INVENTION

The present invention provides an intuitive keyboarding system for any general-purpose computing device that accepts text input and is configured with the appropriate support software. The present invention significantly reduces the number of keystrokes needed for text entry to computers or other types of computing devices including portable handheld devices, such as cell phones, portable digital assistants, or tablet PCs. It does this by enabling keyboarders to enter intuitive codes for most common words, the majority of the words being entered with codes of one, two, or three keystrokes. Word variations and/or plural forms and phrases may require the entry of codes that are 4 or 5 keystrokes. The method of the present invention is described and demonstrated in English but is equally applicable to other languages.

The functional embodiment of the present invention is memory-resident software that captures and evaluates alphanumeric keystrokes beginning and ending with delimiters en route to any computer-based application that accepts text, such as word processing, spreadsheet, web browser, e-mail client, and so on. For each alphanumeric entry between delimiters, known as the user entry, the software scans the two-column table of codes and expansions for a match. When a user entry matches a code, it is replaced in the document by the code's associated expansion in the two-column table. If the user entry is not recognized as a code (no match), the software embodiment of the present invention permits the user entry to remain in the application as entered and readies to evaluate the next user entry.

The present invention provides a set of easily-learned and understood rules that enables keyboarders to enter intuitive codes for most common multi-syllable words and their variations. The codes which are also known in the art as abbreviations are constructed based on sayables and a set of rules. The sayables is defined by the present invention as being one of the distinctly separate sounds in a spoken multi-syllable word, the end and beginning of which are designated by the beginning of the word, the end of the word, or a natural break in the word. The natural break is a momentary change in inflection or emphasis when the word is spoken.

In the present invention, the keyboarder conceptualizes a word, not in syllables, but in sayables. The sayables evolve when the user vocalizes the word, orally or in his or her mind, and the code needed to expand the word or phrase is extracted intuitively from the sayables. For example, the sayables for the example words another, critical, and difference are a-no-ther, cri-ti-cal, and dif-fe-rence. A dictionary-level knowledge of grammatical syntax is not required with the present invention, only the ability to say the word and discern its natural phonetic parts.

For example, the sayables for the word computer are com-pu-ter. It should be noted that sayables may or may not be consistent with a word's syllables (the syllables for computer are com-put-er). Whether the word computer is spoken silently, aloud, or in our mind, the phonetic units become apparent and define the sayables as com, pu, and ter. The sayable representative character is the letter that we naturally associate with a sayable, typically the dominant sound at the start of sayable, that is, the c, the p, and the t in the case of the word computer.

It is important to note that in normal conversation, the t in computer is associated with er (the sayable ter) and not the syllable put. On occasion, the sayable equates to the syllable for some words, but the present invention is based entirely on sayables and has no basis in syllabication.

In the present invention, the keyboarder conceptualizes a word in sayables. The sayables may not be apparent when viewing a written word, but they surface quickly when the word is spoken. A word can be broken into sayables with relative ease by simply saying the word or by vocalizing it mentally. The mental parsing process works either way. Because keyboarders are thinking and reacting on the fly, there is little time to dissect a word into dictionary-defined syllables as suggested in prior art. The sayables in a multi-sayable word typically begin with the dominant sounds in a word as it would be spoken during normal conversation. In the word computer, the letters c, p, and t literally roll off the keyboarder's lips thus forming the three-character code for the word computer—cpt. With practice, dividing or parsing a word into sayables and its associated sayable representative characters becomes a natural and fluid process. As with any acquired skill, the mind and fingers begin to work together such that the sayables, and therefore the characters in the code, translate naturally to the fingers and the computing device's key input device.

The present invention's use of the sayable overcomes the two major obstacles that have precluded the general user from enjoying the productivity associated with rapid key entry of information to a computing device. With the known art, the keyboarder must either memorize the codes for expansions or create codes based on systems that have limitations, these limitations having precluded their use in practice by the general user (see Description of Known Art). The method taught by the present invention enables keyboarders to extract codes directly from the words, so memorization is not required for the entry of common words. Moreover, the method of the present invention is straightforward and natural and can be learned by any keyboarder willing to learn a few simple rules.

The present invention describes a simple process that a user can employ to reduce the number of characters required to enter a word, multiple words, phrases, dates, addresses, and other information (an expansion) that a user may key into a computing device. Applying the process of the present invention to any multiple-syllable root word results in a code consisting of three to five characters, the second and sometimes third characters being mentally parsed from sayables embedded in a word. For the purpose of the present invention, the multiple-syllable root word is defined as any word with two of more syllables, except those that are formed by appending a prefix or suffix to a one-syllable word. For example, the words redo and being are not considered root words within the context of the present invention.

In the present invention codes are formed based on the sayables in the root word. The root word is the basic word from which variations are formed. For example, associate is a root word whose code is asc (as-so-ciate). The codes for the root word's variations are based on the root word's code. For example, the codes for associates, associated, associating, association, and associations are ascs, ascd, ascg, ascn, and ascns.

The root words are either two-sayable words or three-sayable words. Two-sayable words have only two sayables, no more or less. Question and forward are two-sayable words. Questionnaire and forwarding are variations. All other root words are three-sayable words. Fourth and subsequent sayables are irrelevant. Vocabulary and potential are three-sayable words. Vocabularies and potentially are variations. The two- and three-sayable root words are inserted into a document by keying only the root word codes which are the first letter of the word plus the sayable representative characters for the second and third sayable for three-sayable root words. or, in the case of two-sayable words, the first letter of the word, the sayable representative character for the second sayable, plus a void identifier, an x in one embodiment of the present invention. The void identifier indicates that a third sayable is not present in the code for an expansion. The codes for the two-sayable words, question and forward, are qtx and fwx, respectively. The codes for the three-sayable words, vocabulary and potential, are vcb and ptt, respectively. The codes for variations, such as questionnaire and vocabularies, are formed by appending a prefix identifier, called a prefix-ID, or one or more suffix identifiers, called a suffix-ID, to the three characters of the root word's code. For example, the codes for vocabularies and questionnaire, which require suffix-IDs, are vcbs and qtxa, respectively. The prefix-ID and suffix-ID characters of the present invention have pre-defined meanings. For example, the suffix-ID s defines a word that is the plural form of a noun and the suffix-ID a causes the suffix “aire,” “age,” “sia” to be appended to the root word, as appropriate. In the same way that a suffix-ID is appended at the end of a root word's code, the prefix-ID is added at the beginning to append the most common prefix for the root word. In one embodiment of the present invention, the letter q is the universal prefix-ID. For example, the code qctu expands to discontinue.

It is inevitable that some words or word variations will parse to the same code. Because of this, the present invention provides for methods of distinguishing non-unique codes for words or word variations. The present invention uses a method of appending a number (1, 2, 3 . . . 9) to non-unique codes to enable multiple unambiguous entries to the two-column table of codes and expansions. For example, the sayables of logistic, legitimate, linguistic, and longitude parse to the code lgt. When this happens the present invention associates the most commonly-used root word with the basic three-character code, then assigns numbers to the others based on their frequency of use. In this example, the codes for logistic, legitimate, linguistic, and longitude are lgt, lgt1, lgt2, and Igt3. To assist a user in determining the proper code, an implementable software embodiment of the present invention provides a pop-up options list box, the pop-up box being well known by those skilled in the art, that displays the codes and their expansions when an entered three-character code is not unique.

The core of the present invention is the ability to enter most common words rapidly via intuitively derived codes in collaboration with a comprehensive two-column table. However, languages invite other approaches to realizing even greater productivity in keyboarding, so the core capability of the present invention is complemented by other methods for rapid entry of text. Special rules and circumstances are created for quick entry words that appear frequently in keyboarding. Quick entry words are high-frequency entries that typically appear several times in any given sentence, such as common prepositions, including between and within, and very high-use words such as have, people, could, and other. Quick entry codes are one or two characters.

The core capability is further complemented within the present invention with intuitive codes in the two-column table for a number of word combinations that are stated as a single thought, such as status quo and upside down. Also, the present invention's two-column table has codes for hundreds of hyphenated word combinations that occur frequently in writing, such as goal-oriented or ready-to-use. Commonly-used acronyms are assigned intuitive codes that can be entered to expand the acronym. For example, in one embodiment of the present invention, ngoq expands to non-government organization. A number of common phrases, chat/text messaging shorthands, and sentences/fragments can be inserted with intuitive codes, as well.

The present invention includes a number of other features designed to further enhance interactive productivity with a computing device. Intuitive codes in the two-column table permit users to insert the names of keys on the keyboard, hundreds of first or last names, hundreds of geographic locations including cities, states, countries, and specific locations. The present invention is further extended to provide intuitive codes that enable users to expedite the entry of spelled-out numbers. Days of the week, months, and major holidays are entered quickly via short intuitive codes.

The present invention discloses a method that enables users to open the default browser to a website listed in the two-column table during in-line keyboarding in any application. Users can open to the home page of a specific search provider in the default web browser and initiate a search for a specific search string during in-line keyboarding.

The present invention encompasses the ability to customize the two-column table for use in a specific environment—personal, corporate, professional, and so on. Codes for custom words, phrases, sentences, acronyms, and so on are constructed in the same manner as they are for the core two-column table. In one embodiment of the present invention, the custom identifiers, known as a last-ID in the present invention, is employed to distinguish the custom codes from the core codes already in the two-column table. For example, the code for the custom word sayable is sabj. The customization feature of the present invention provides a method for rapid entry of information within the context of 11 common categories, including addresses, directions, boilerplate, and so on.

It is an object of this invention to avoid or alleviate the shortcomings of the prior art.

It is a further object of the present invention to provide a productivity tool that is intuitive and easy to learn so that it can dramatically increase the number of users of computing devices who can enjoy the benefits of a keyboarding productivity tool.

It is a further object of the present invention to provide a keyboarding productivity system that can be effectively used with multiple computing devices, including desktop computers, laptop computers, personal digital assistants and other handheld devices that employ a full QWERTY keyboard.

It is a further object of the present invention to provide a productivity system that can be effectively used with cell phones, handheld devices, and other computing devices that do not employ a full QWERTY keyboard.

It is a further object of the present invention to increase keyboarding productivity by allowing a customizable two-column table that allows users to develop their own codes and respective expansions.

It is a further object of the present invention to increase the user's productivity during interaction with a computing device at work, at home, and at leisure, thus saving time and/or money.

It is a further object of the present invention to minimize fine hand movements, repeated throughout the day, often thousands of times, which eventually strain the muscles and tendons of the fingers, wrists, and forearms resulting in microscopic tears. Thus, another object of the present invention is to reduce fatigue and the potential for repetitive stress injuries (RSI) associated with keyboarding.

It is a further object of the present invention to minimize the spelling issues associated with keyboarding to enable a more fluid entry of text and reduce the mental stress resulting from start/stop keyboarding.

It is a further object of the present invention to allow users of computing devices to work smarter, not harder, by giving them productivity gains that result in more time and energy being available to focus on the task at hand.

It is a further object of the present invention to be an assistive technology that will enable people with disabilities to interact more efficiently with a computing device and to communicate better, especially those who must use cumbersome alternative input devices that employ sip-and-puff or eye movement technologies.

It is a further object of the present invention to make keyboarding significantly more effective for all people who have no formal training in keyboarding skills.

### BRIEF DESCRIPTION OF THE DRAWINGS

In the following drawings, which form a part of the specification and which are to be construed in conjunction therewith, like reference numerals have been employed throughout wherever possible to indicate like parts in the various views.

FIG. 1 is a schematic view of a computing device that provides the operational environment for the preferred embodiment of the present invention.

FIG. 2 is an overview flow chart illustrating the present invention's process for handling a user entry, during which a code is matched and the user entry is replaced by an expansion.

FIG. 3 is a flow chart illustrating the relationship and interactions between the major components of the keyboarding system of the present invention during a keyboarding session.

FIG. 4 is a schematic of the mental parsing process to evaluate a word, to identify its sayables, and to determine a code to be entered in lieu of an expansion.

FIG. 5 is a logical flow chart illustrating the common expansion procedure for entering a code to be expanded to a root word.

FIG. 6 illustrates the graphical user interface during entry of a code that logically associates with multiple expansions.

FIG. 7 is a logical flow chart illustrating the optional expansion procedures for entering quick entry codes and codes for phrases, names, geographic sites, and so on, to be expanded to their respective expansions.

FIG. 8 is a logical flow chart illustrating the custom expansion procedures for entering custom codes to be expanded to their respective custom expansions.

FIG. 9 is a logical flow chart illustrating the Internet or Help procedures for interacting with the web browser and requesting assistance during a keyboarding session.

### DETAILED DESCRIPTION OF INVENTION

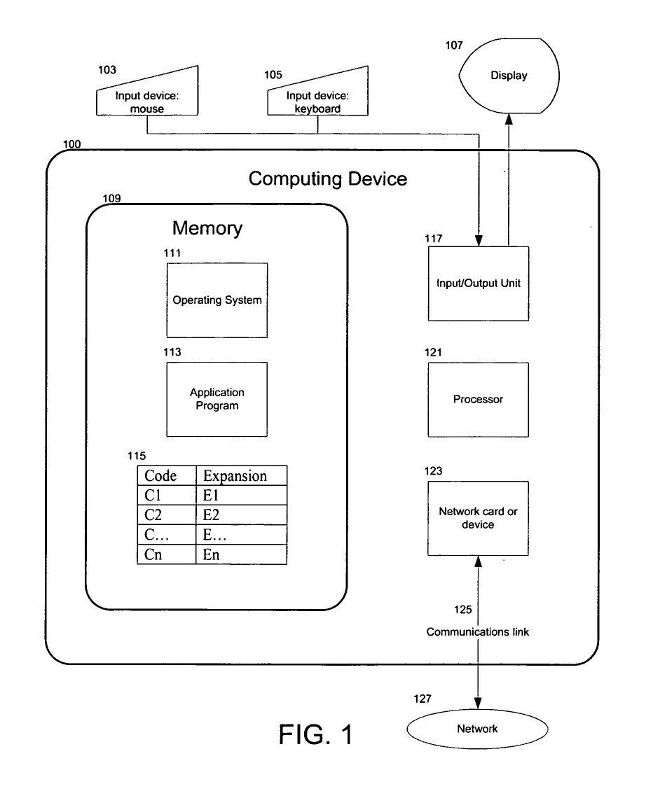

FIG. 1 shows an exemplary environment for implementing the present invention's system for intuitive coding to enter text expansions. The computing device 100 in FIG. 1 shows a hardware setup for executing software that allows a user to employ the present invention to expedite text entry. The general-purpose computing device 100 includes a processor 121, an input/output unit 117, memory 109 that stores various programs such as an operating system 111, one or more application programs 113, and data, such as the two-column code/expansion table 115. The drawing does not include some components of the standard computer system because they are well know in the art and are not necessary to understanding of the present invention. The computing device 100 links to various input/output devices (a mouse or functionally equivalent point/draw device 103, a keyboard or functionally equivalent character input device 105, and display 107). The computing device 100 preferably will include some sort of communications card or device 123 for exchanging data with a network 127 via a communications link 125.

The software supporting the preferred embodiment of the present invention is a set of instructions that may be executed on a conventional computing device, including but not limited to a personal computer, a personal digital assistant, a cell phone, or other hand held computing device known in the art. The processor 121 may provide output information to a display 107 or other output devices, such as a printer, to display text or graphics according to instructions from the processor 121 during execution of a program. The processor 121 may also receive input data from a number of input devices 103, 105 that allows a user to enter information. The keyboard devices include keys for entering alphanumeric characters, punctuation marks, and symbols, and for activating pre-defined functions. Henceforth the term character will refer to named characters or other symbols found on a keyboard or on other input devices that permit character entry. Such input devices are well known in the art.

The computing device 100 may support a variety of programs that permit entry of text data into the memory 109 and the display of the same on the display 107. The programs, to varying degrees, enable users to edit the text data. The present invention contemplates use with programs such as word processing, e-mail client, web browser, spreadsheet, database, text messaging, personal organizer, and other software that permits text entry via a keyboard or key input device 105. The present invention used in conjunction with appropriate software complements these popular programs. The use and operation of the text editor functions within these programs is well known in the art.

The present invention provides a method and system for intuitive coding to enter text expansions for any general-purpose computing device that accepts text input and is configured with the appropriate support software, all of which comprise a keyboarding productivity system. The present invention enables the general user to enter text to a computer or other type of computing device with significantly fewer keystrokes than traditional entry at one character at a time. The present invention describes a new approach to keyboarding that can dramatically speed the entry of text to a variety of computing devices. It does this by enabling keyboarders to enter short intuitive codes in lieu of entering most common words one character at a time. The code for any common word is known instinctively by saying the word and employing the invention's mental parsing process. The majority of common multiple-syllable words are entered with codes of one, two, or three keystrokes. For example, the word multiple is inserted into the text entry area of the program when the user keys the code mtp and taps a delimiter, such as a space or punctuation mark. Word variations and/or plural forms and phrases may require the entry of codes that are four or five keystrokes.

The functional embodiment of the present invention resides in a computing device's memory 109 as memory-resident software that captures and evaluates alphanumeric keystrokes between delimiters en route from the keyboard to any application that accepts text. The alphanumeric entry between delimiters is described within the present invention as the user entry, which can be a code or any text entry. For example, many short words, such as word, are not coded and are entered directly one character at a time. The same is true of seldom-used words, such as makimono. When the software that supports the present invention detects a user entry, the two-column table 115 containing the codes and their associated expansions is scanned for a match. When a user entry matches a code, it is replaced in the document by the code's associated expansion from the two-column table. If the user entry is not recognized as a code within the two-column table, the software embodiment of the present invention permits the user entry to remain in the document as entered and readies to evaluate the next user entry.

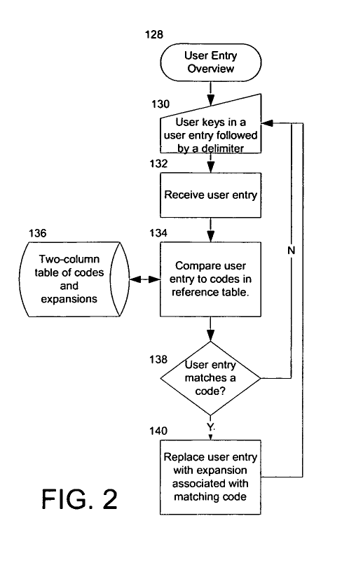

As shown in FIG. 2, the present invention enables a keyboarding productivity system that replaces a user entry with an expansion. The present invention functions with word processing, web browser, or any other program that accepts a text-based user entry (User Entry Overview 128). A user of the present invention enters a user entry on an input device at User Keys in User Entry 130. The entry is received into the keyboarding productivity system at Receive User Entry 132 when the present invention detects that a delimiter character has been entered. The user entry delimiter, generally a non-alphanumeric key, signals the present invention that a user entry has been entered. The system compares the user entry to codes in the two-column table at Steps 134 and 136. At User Entry Matches a Code 138, the present invention determines whether or not there is a code in the two-column table that matches the user entry. If there is no match, the user entry is unchanged and the system awaits another user entry at Step 130. If there is a match, the system replaces the user entry in the display with the expansion that is associated with the matching code at Step 140 and then the system awaits another user entry at Step 130.

### Major Components of the Present Invention

The present invention refers to a method and system for intuitive coding to enter text expansions that optimizes a keyboarder's ability to enter text rapidly to a computing device. The present invention is an integration of the following four components, all of which work together within one system to enable users to achieve maximum keyboarding effectiveness.
Common expansion procedure via sayable-based codes. The first component is designed to handle the preponderance of multiple-syllable words that occur during normal text communication by using a method that enables keyboarders to expand thousands common words by keying intuitive sayables-based codes derived via a mental parsing process of the word itself.
Optional expansions procedures. The second component of the present invention presents methods for rapid entry of a much smaller population of words: those that occur in virtually every sentence, common phrases, and words/phrases in a variety of frequently occurring categories of words, including geographic locations, proper names, written numbers, holidays, and so on.
Custom expansion procedure. The present invention describes methods for user customization of the two-column table to embody entries for use in a particular personal, corporate, or professional computing environment. The present invention provides rules for forming custom codes and expansions that are consistent with the two-column table, plus the customization process employs methods for expanding text within a variety categories, including addresses, website URLs, e-mail addresses, and more.
Internet and Help procedures. The present invention embodies the facility to interact with the Internet during in-line keyboarding within a text entry area of an application, such as word processing. The in-line Internet feature opens the default browser to a coded website and, also, it displays the results of an in-line query to a specific search provider for a user-entered search string. The in-line Help facility also is accessed during in-line keyboarding. The facility provides a table lookup capability that permits the user to enter an expansion and view its code.

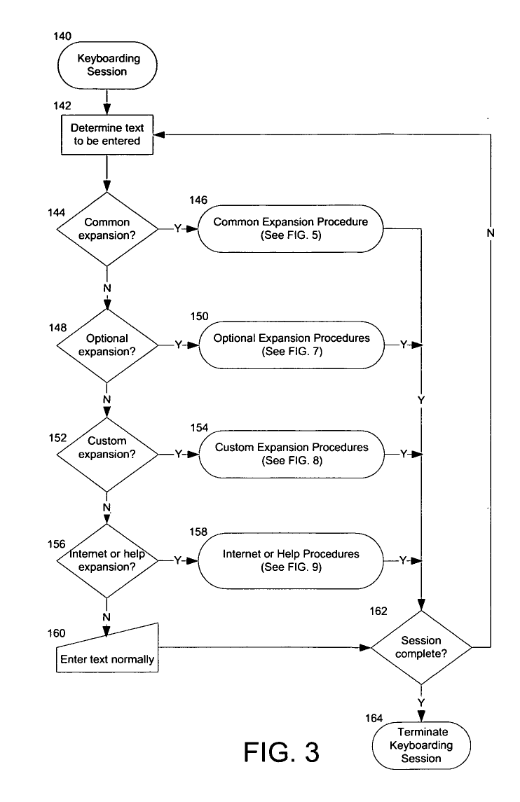

FIG. 3 provides a graphical overview of how the keyboarder, the user, might employ the above four components of the present invention during a keyboarding session to increase keyboarding productivity. During Keyboard Session 140, a user keys as many user entries as needed during the session. When used in conjunction with a computing device and appropriate software the present invention allows the user to enter text normally or enter a common expansion, an optional expansion, a custom entry, and to access internet or Help features. The present invention scans the two-column table and replaces a user entry that matches a code with its associated expansion. As shown at Determine Text to be Entered 142, a user determines the user entry to be entered. The user enters text normally one character at a time or via codes that are expanded automatically according to procedures described by the present invention. The user entry is determined to be normal text if a match is not found for the code in the two-column table. The text structure of the user entry determines whether it is a common expansion code, an optional expansion code, a custom entry code, a call for Internet interaction or help, or normal text.

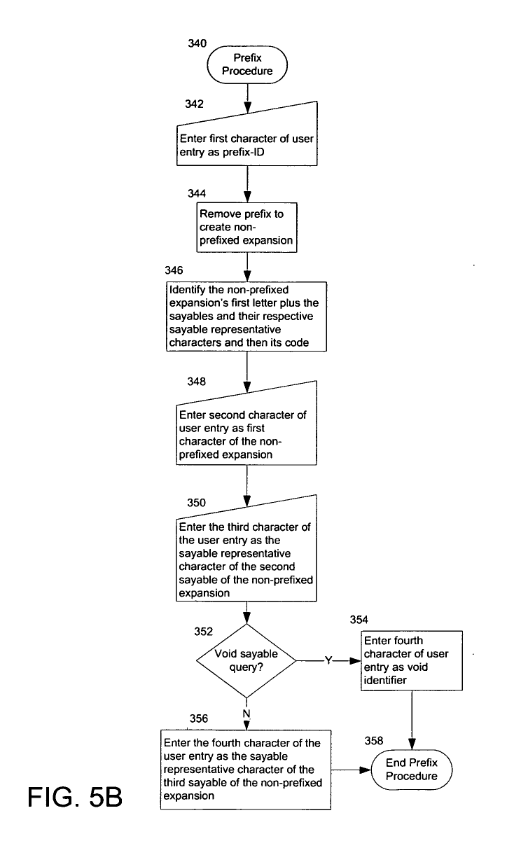

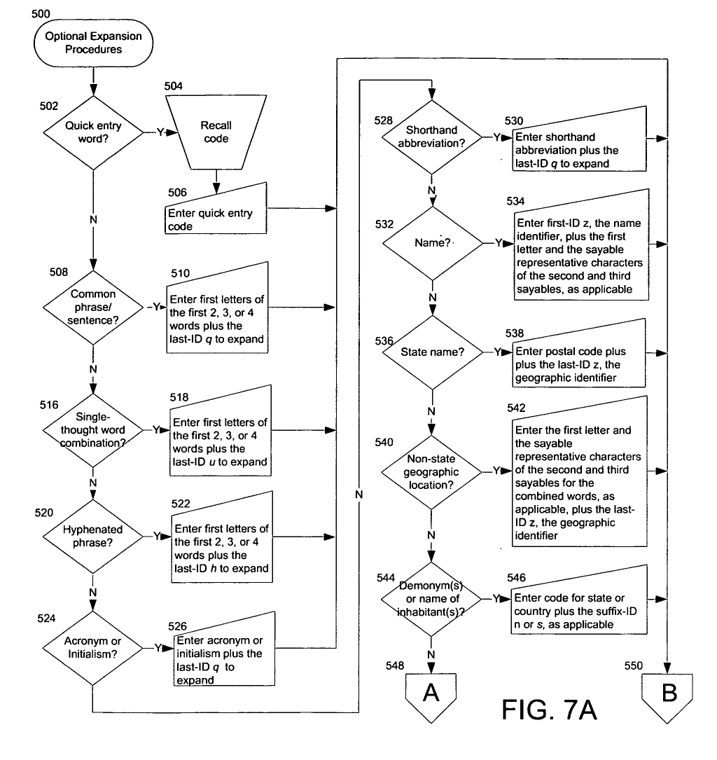

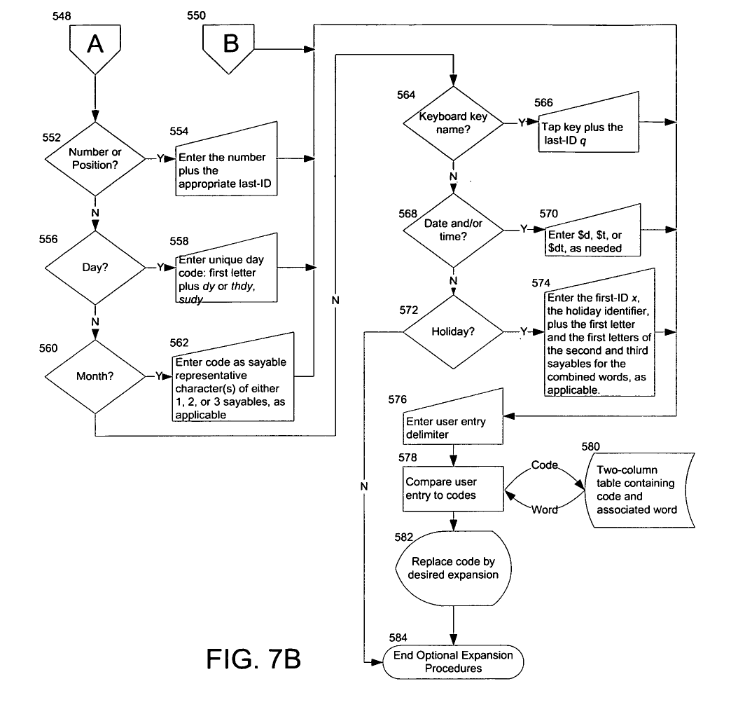

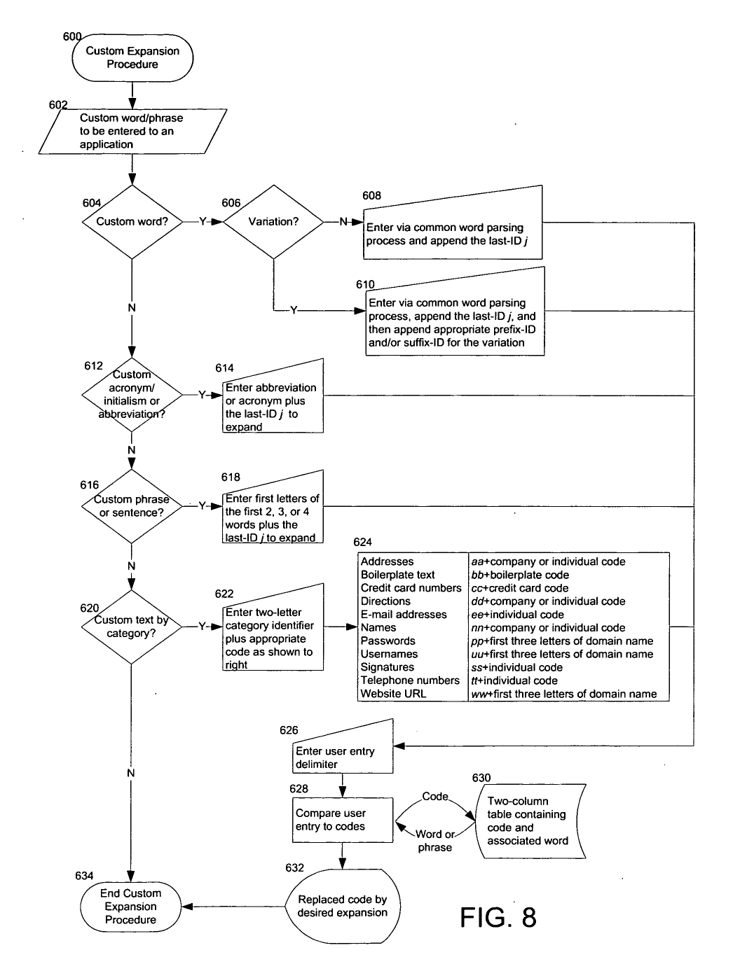

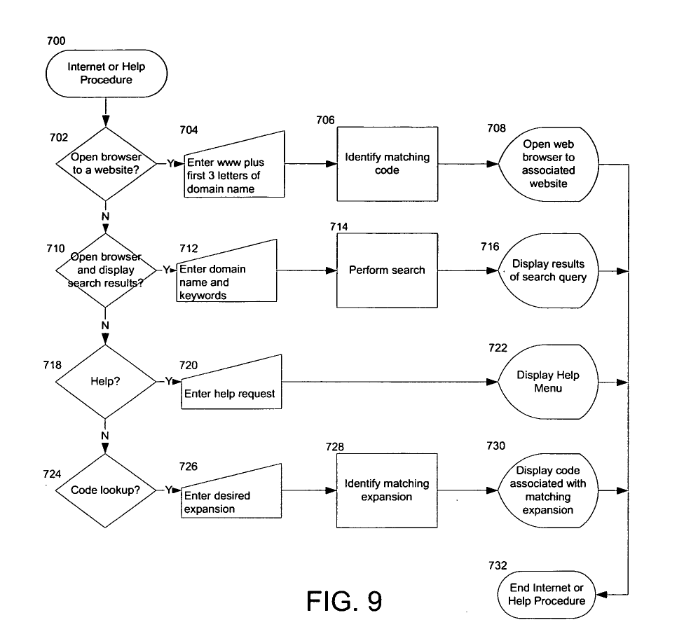

If the user entry is a common expansion at the Common Expansion Procedure query 144, the user inputs the user entry according to the present invention's Common Expansion Procedure 146 as shown in FIG. 5. If the user entry is for an optional expansion at the Optional Expansion query 148, the user inputs the user entry according to the present invention's Optional Expansion Procedures 150 as shown in FIG. 7. If the user entry is for a custom expansion at the Custom Expansion query 152, the user inputs the user entry according to the present invention's Custom Expansion Procedures 154 as shown in FIG. 8. If the user entry is a call to interact with an Internet or use the Help facility at the Internet or Help Procedure query 156, the user inputs the user entry according to the present invention's Internet or Help Feature Procedure 158 as shown in FIG. 9. Otherwise, the user entry is accepted as normal text at Enter Text Normally 160 and is not affected by the procedures of the present invention. After the completion of the Common Expansion Procedure 144, the Optional Expansion Procedures 148, the Custom Expansion Procedures 152, the Internet or Help Procedure 156, or the Enter Text Normally 160, the procedure of the present invention advances to the Session Complete query 162. If the session is not complete, the present invention returns to Determine Text to be Entered 142 to allow another user entry. If the user has no more user entries, the session is complete at Terminate Keyboarding Session 164.

The present invention is presented in separate presentations for each of the four basic components summarized above and shown in FIG. 3.

### Common Expansion Procedure Via Sayable-Based Codes

The present invention provides a set of easily-learned and understood rules that enables keyboarders to enter intuitive codes for most common multi-syllable words and their variations. The codes are also known in the art as abbreviations. In the present invention, the codes are constructed via a mental parsing process based on sayables and a set of rules. The sayable, an important element of the present invention's system of creating and recalling the intuitive codes, is a natural by-product of human thought. However, a definition and description of the sayable is best understood when prefaced by an overview of the research that led to making the sayable the foundation of the coding system of the present invention.

In a text expansion system, a keyboarder keys in an alphanumeric code to insert an expansion into an application. To achieve the desired effect—increased keyboarding productivity—the process associated with entering the code must adhere to these criteria.
1. The process must be intuitive. Keyboarding is inherently a fluid process wherein any improvements in productivity are gained through instinctive actions, not time consuming actions that involve calculation or complex thought.
2. The process must be simple. The typical keyboarder is already preoccupied with the mental challenges associated hand-eye coordination, so any other mental tasks must be straightforward and simple to do and understand so that keyboarding can continue unabated on-the-fly.
3. The process must be fast. The basic objective of a coding system is to reduce the time required for a keyboarder to enter text to a computing device, so the speed at which a code is entered is critical.
4. The process must be enablinaugurate to the preparation of a comprehensive database. A two-column table of codes and expansions, the database, containing all common words and phrases is a prerequisite for a universally useful text expansion system.

The research for the present invention began with the syllable, the logical starting point. The potential for adopting the syllable as the bases for the coding scheme was evaluated against the criteria. The syllable is well known to anyone familiar with the entries in a dictionary. A word will normally have as many syllables as it has separate vowel sounds. The syllables are shown in any dictionary for every multi-syllable word listed. Using the syllable as the basis for creating a coding system, though, is not an option because it fails to comply with three of the four criteria. It is not intuitive or simple. Few native English speakers are able to syllabify words with any degree of accuracy without the use of a dictionary. To employ the syllable as a means to determining the sayable, the keyboarder would need to either study and learn the syllables for thousands of words or apply the complex rules of syllabication to every word to be expanded. It is unrealistic to assume that a keyboarder can learn and accurately recall the syllables of tens of thousands or words on-the-fly while keyboarding. It is equally unrealistic to expect a keyboarder to apply the many rules of syllabication for each code. The following rule is representative of the 19 common rules of syllabication: When a single consonant comes between two vowels in a word, it is usually divided after the consonant if the vowel is short. Even if the rules were known to the keyboarder, applying the rules may not result in the dictionary syllabication because so many of the rules include a disclaimer or qualifier, such as “usually,” “sounded alone,” or “sounded separately.” Finally, creating a comprehensive database based on syllables may be undoable because any syllables-based coding system could never accommodate the criteria that the process be intuitive, simple, and fast.

Modern English linguistics defines the syllable using rules of syntax, but the living language is more readily and easily conceptualized in phonetic units, which are akin to spoken syllables. The sayable is defined as being one of the distinctly separate sounds in a spoken multi-syllable word, the end and beginning of which are designated by the beginning of the word, the end of the word, or a natural break in the word. The natural break is a momentary change in inflection or emphasis when the word is spoken. Speech has a natural rhythm that enables the sayable to emerge as the word is spoken without the need for formal rules of syntax, thus making it intuitive. The sayable meets all of the criteria to be the foundation for identifying the characters used to form a code; that is, it is intuitive, simple, fast, and enables the creation of a database of codes and expansions.

A sayable is represented by a sayable representative character within the codes of the present invention's coding system. The following rules describe the sayable representative character.
The sayable representative character is an alphabetic letter.
The sayable representative character is the letter that we naturally associate with a sayable, typically the dominant sound at the start of sayable (see rules below).
The sayable representative character occurs one or two times within either a three-character root word code or a code for a root word variation, which can have three, four, five, or six characters.
A sayable representative character is the second letter of the three-character code for two-syllable root words.
A sayable representative character is the second letter and the third letter of the three-character code for root words with more than two-syllables.
The sayable representative character is extracted from a root word's sayable or sayables via a mental parsing process that employs the mind's computer-like ability to perform this procedure when the word is spoken or uttered with a natural cadence, inflection, and rhythm.
   1. If the root word has only two vowel sounds (a two-syllable word), the sayable representative character is the first letter of the second sayable, subject to the rules that follow. This sayable representative character is inserted as the second character of codes for two-syllable root words.
   2. If the root word has more than two vowel sounds (three-plus syllable word), the sayable representative characters are the first letters of the second and third sayables, subject to the rules that follow. These sayable representative character are inserted as the second and third characters of codes for three-plus syllable root words.

Exceptions:
The first letter of sayable inconsistent with the sound. The sayable representative character is always the actual first letter of the sayable and not the letter that might be more representative of the sound. For example, the sayable representative characters for dictionary are t and n, not s and n.
The “y” sound. When the sayable begins with the “y” sound as heard in “yellow,” use the first letter in the sayable as it is spelled. For example, the sayable representative character for the word brilliant is i.
The “x” sound. An “x” triggers the beginning of a sayable for a number of words, often with an “sh” or “s” sound. When this happens, the x is the sayable representative character in the code. For example, the x is the first a sayable representative character in luxury. An exception to this rule is when a word begins with “ex”. In this case, the sayable representative character is the letter following the x, thus the first sayable representative character in excellent is c.
The ck. When ck begins the second or third sayable, the sayable representative character is a k. For example, the sayable representative character for package is k.
The silent sayable representative character. When the sayable logically begins with a silent letter, the actual first letter is still the sayable representative character. For example, the h in exhibit is a sayable representative character. The first letter of the code for psychiatry is pca, not sca.

The present invention discloses a method wherein the first letter and up to two-sayable representative characters define the code for a root word. The three-character codes for most three-plus syllable words in the two-column table are formed according to this rule: [1^{st} letter] [1^{st} sayable representative character] [2^{nd} sayable representative character]. The code for the word character is crt: [cha] [rac] [ter]. The first letter of the code is always the actual first letter of the word, not the sound. For example, the code for photograph is ptg.

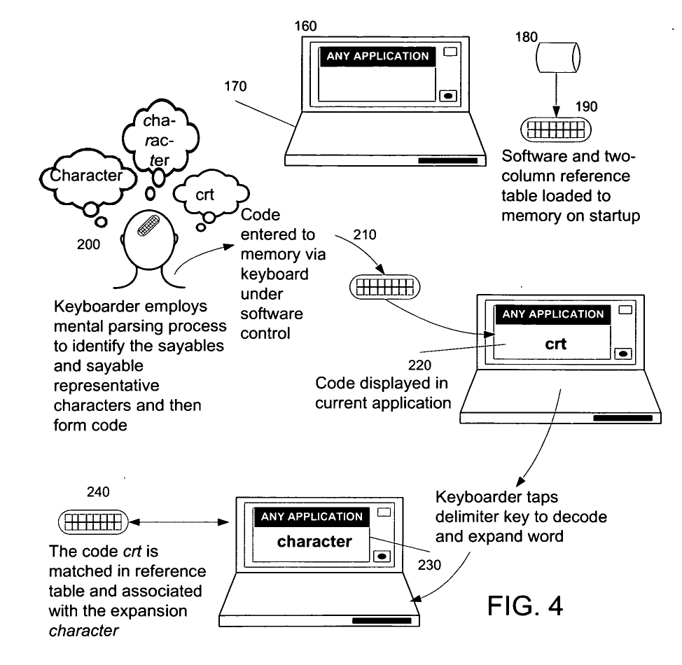

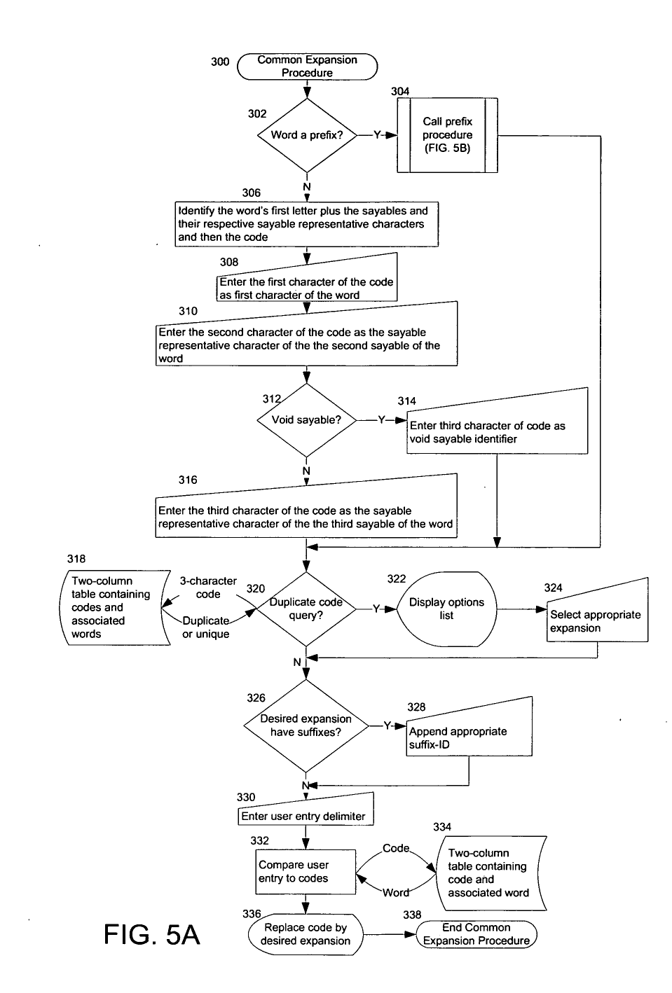

FIG. 4 illustrates the present invention's method of mentally extracting codes from words and using the codes to expand words. The computing device 160 is turned on and application software 170 is loaded. The present invention as depicted in FIG. 4 is the same and equally applicable to handheld devices, such as PDAs and cellular phones. The software and the two-column table in support of the present invention are loaded from hard disk 180 to memory 190 (109 in FIG. 1) on system startup. The keyboarder at Step 200 employs the mental parsing process and rules taught in the present invention to identify the word's first letter plus the sayables and their respective sayable representative characters for the word character, cha-rac-ter, and then the code, crt. At Step 210, the user keys in c r t within any software application that accepts text entry. The code is captured by the present invention's software in memory and displayed in the application at Step 220. At Step 230, the user taps a delimiter key, any non-alphanumeric key in one embodiment, to initiate a search of the memory-based two-column table 240 for a code match. When the match for the code crt is found, the associated expansion, the word character in the example, is displayed in the current application.

Table 2 shows other examples of common words and their codes, which are derived from the first letter and the sayable representative characters.

TABLE 2

| | |
|---|---|
| abbreviate | abv |
| appropriate | app |
| beautiful | btf |
| category | ctg |
| combination | cbn |
| community | cmn |
| company | cpn |
| develop | dvl |
| dictionary | dtn |
| eventual | evt |
| example | eap |
| fundamental | fdm |
| photograph | ptg |
| resistant | rst |
| supplement | spm |
| typewriter | twt |

Although the sayable may be the same as the syllable for some words, the present invention is based entirely on sayables and has no basis in syllabication. The words category, develop, dictionary in Table 2 are examples of words that diverge from syllabication. The syllables for the example word in FIG. 4, character, are char-ac-ter, but in spoken conversation the r is associated with the ac to create the second sayable. Therefore, the sayables for character are cha-rac-ter. Consider also the code for satisfy, stf. People say sa-tis-fy, not sat-is-fy. Associating the trailing consonant of a syllable with a different phonetic unit is especially common when the syllable is a single vowel. For example, the i in dominate is a separate syllable, but when the word is pronounced, these sayables emerge: do-mi-nate. A single vowel, though, can define a sayable and even a sayable representative character, as in manufacture, whose code is muf:

For the purpose of the present invention, the multiple-syllable root word is defined as any word with two or more syllables, except those that are formed by appending a prefix or suffix to a one-syllable word. For example, the words redo and being are not considered root words within the context of the present invention. The words in the present invention's two-column table are in three categories.
Two-sayable words. Two-sayable root words have only one sayable representative character, which is associated with the second sayable. Knowledge and grammar are two-sayable words.
Three-sayable words. All other multi-syllable root words have two-sayable representative characters, which are associated with the second and third sayables. Determine and tradition are three-sayable words.
Variations on two-and three-sayable words. Variations on two-and three-sayable words are word forms based on a root word. Knowledgeable and grammatical are variations of the root words knowledge and grammar, respectively.

Three-sayable words are expanded in an application by keying only the word's first letter and the sayable representative characters associated with the second and third sayable. This is the rule for three-sayable word codes.
Code₃=[1st letter] [1st sayable representative character] [2nd sayable representative character]

Two-sayable words are expanded in an application by keying only the word's first letter, the second sayable's sayable representative character, and a void identifier x. The void identifier x must be added in the third position of the code for one-sayable words so as not to conflict with three-sayable words when a character is appended to a two-sayable code that is associated with a variation to a root word. This is the rule for constructing codes for two-sayable words.
Code₂=[1^{st} letter] [sayable representative character]x

For example, the code vcb [voc-ca-bulary] expands to vocabulary and the code hlx [high-light] expands to highlight. The unique combinations formed by these characters provide a code that identifies a word to the present invention's two-column table of codes and expansions. The user taps a delimiter after entering a code to expand it to the desired word. With practice, many of the present invention's codes for frequently-used words are committed to muscle memory, similarly to the and with are in traditional keyboarding.

The root words frequently have one or more variations. For example, the variations for the root word implement are implements, implementing, implemented, implementable, implementation, implementations, implementer, and implementers. The root word resource has these variations, resources, resourcing, resourced, resourceful and resourcefully.

The present invention's suffix-ID, a single predefined and intuitively applied letter can be appended to the root word's code to expand it to one of its variations. The codes for the aforementioned variations of implement (ipm) are ipms, ipmg, ipmd, ipmb, ipmn, ipmns, ipmr, and ipmrs, respectively.

The present invention's rule for forming codes for variations of root words follows.
Codeᵥ=[root word 3-character code] [suffix-ID] [optional s for plural variations]
   Two of the most commonly applied suffix-IDs are s to a plural noun or singular verb and d for past tense. In most instances the suffix-ID letter is intuitive. The appropriate suffix-ID is appended to the root word code based on the ending of the desired word according to the rules shown in Table 3.

TABLE 3

| | | Examples | |
|---|---|---|---|
| Suffix- | | | Entered to |
| ID | Ending of Desired Word | Code | Application |
| a | aire, age, sia | qtxa | questionnaire |
| | | itla | intelligentsia |
| b | able, ible | csdb | considerable |
| c | ic | stgc | strategic |
| | ance or ence (applies only as a | snfc | significance |
| | variation to an “ent” or “ant” word) | cfdc | confidence |
| d | ed or the past tense verb form (can be | itad | interacted |
| | applied to a root word or a variation) | bcxd | became (past |
| | | | tense of |
| | | | become) |
| e | use when appended to a common root | rtne | rationale |
| | word to make a different word, such | mgxe | mortgagee |
| | as in morale and finale | | |
| | ee | | |
| g | ing, ogue | mufg | manufacturing |
| | | idog | ideologue |
| h | hood | prxh | parenthood |
| i | ize, ish, ide, i | apli | apologize |
| l | al, ful, full, less, self | oprl | operational |
| | | rgxl | regardless |
| m | ment, man, men, ism, um, am, most | dvlm | development |
| | | ntnm | nationalism |
| n | tion, sion, ence, ance, an, en, ern, | ipmn | implementation |
| | ness | sron | seriousness |
| o | ous, ious, io, oid, o | avto | advantageous |
| | | rlgo | religious |
| p | ship, graph | cpop | championship |
| r | er, or, ur, ure | dvlr | developer |
| s | s (plural noun, which can be applied | mmrs | memories |
| | | | (a noun) |
| | to a root word or a variation; singular | vlds | validates |
| | verb) | | (a verb) |
| t | ate, ite, ant, ent, est, ist, ette | csdt | considerate |
| | | pclt | psychologist |
| v | ive | cphv | comprehensive |
| | | atnv | alternative |
| w | woman, way | svxw | servicewoman |
| y | ary, ility, ally, ology, or any word | stxy | systematically |
| | variation ending in y, including cy, | rvly | revolutionary |
| | dy, fy, ly, ry, sy, ty, vy, and so on. | csqy | consequently |
| | | crty | characteristically |

The suffix-ID that creates the plural of a root noun, s, can be applied either to the root word or one of its variations. Just add an s to a code to enter the plural form of the word. For example, enter ctgs for categories or ctrs for criteria. The suffix-ID, s, is also used with verbs to create the singular form. For example, hsts is the code for hesitates.

The method of the present invention is to append the suffix-ID d to a root word or a variation to make a word past tense. For example, enter dvld to insert developed or apxd to become appointed. Appending the suffix-ID inserts a variation to a word in the two-column table and may result in the addition of a few letters to the base word and/or cause one of more letters to be dropped.

Table 4 illustrates the codes for several root word variations.

TABLE 4

| | |
|---|---|
| abbreviation | abvn |
| appendices | apds |
| appropriately | appy |
| beautifully | btfy |
| combination | cbns |
| communication | cmnn |
| companies | cpns |
| development | dvlm |
| dictionaries | dtns |
| eventually | evty |
| examples | eaps |
| fundamentally | fdmy |
| photographer | ptgr |
| resistance | rstc |
| supplemental | spml |
| typewriters | twts |

In the same way that a suffix-ID is appended at the end of a root word's code, the prefix-ID is added at the beginning of a root word. These might include anti, counter, cyber, com, de, dis, multi, re, semi, sub, tri, under and others.

The method of the present invention prefaces the code with the prefix-ID to append the most common prefix to a root vocabulary word. In one embodiment of the present invention, the letter q is the universal prefix-ID. For example, qctu expands to discontinue and qppl becomes unpopular. A prefix-ID and a suffix-ID can be appended to either end of a word, such as in unabbreviated (uabvd) and misunderstanding (qudsg). The codes for words with prefixes to root words are formed using this rule and illustrated in Table 5.
Codeₚ=q[root word 3-character code] [optional suffix-ID]

TABLE 5

| Prefix- | | | | Entered to |
|---|---|---|---|---|
| ID | Prefix | Core Word | Code | Application |
| q | anti | establishment | qetbm | antiestablishment |
| q | bi | partisan | qpts | bipartisan |
| q | bio | engineering | qegng | bioengineering |
| q | co | coordinator | qcodr | co-coordinator |
| q | counter | intelligence | qitlc | counterintelligence |
| q | cross | reference | qrfr | cross-reference |
| q | de | personalize | qpsni | depersonalize |
| q | dis | interest | qitr | disinterest |
| q | electro | mechanical | qmcnl | electromechanical |
| q | grand | children | qcdx | grandchildren |
| q | hyper | critical | qctc | hypercritical |
| q | ir | regular | qrgl | irregular |
| q | mal | adjusted | qajxd | maladjusted |
| q | micro | biology | qbol | microbiology |
| q | mis | information | qifm | misinformation |
| q | multi | disciplinary | qdcpy | multidisciplinary |
| q | non | performing | qpfxg | nonperforming |
| q | over | capacity | qcpc | overcapacity |
| q | re | engineer | qegn | reengineer |
| q | semi | automatic | qatmc | semiautomatic |
| q | tele | communication | qcmnn | telecommunication |
| q | trans | continental | qctnl | transcontinental |
| q | under | developed | qdvld | underdeveloped |

The embodiment of the present invention for how a user enters a code to be expanded to a common word is illustrated in FIG. 5A and FIG. 5B, Common Expansion Procedure 300. The present invention allows common user entries for common expansions, with and without prefixes. A determination is made at the Word a Prefix query 302 as to whether or not the word to be expanded has a prefix. If the word to be expanded is a prefix word, such as misunderstand or unfortunate, Call Prefix Procedure 304 in FIG. 5A is completed (Steps 340-358 in FIG. 5B). The prefix procedure illustrates how the present invention enables a prefix-ID to be appended to a common user entry to expedite the entry of common expansions with prefixes.

If the word is a non-prefix word, the user must first employ the mental parsing process described in detail earlier to identify the sayables of the word at Identify Sayables and the Code 306 before entering a code to be replaced by an expansion. A word is divided into sayables with relative ease by simply saying the word or by vocalizing it silently to determine the sayable representative character The mental parsing process works either way. The first character of the common code is always the first character of the word to be expanded and is entered at Step 308. The second character of the code, which is the sayable representative character of the second sayable of the expansion, is entered at Step 310. Only the first letter of the word plus the second and third sayables are used to create the code. The need for a third character or a void identifier is determined at the Void Sayable query 312. If there is no third sayable, then the user inserts a void identifier, x in one embodiment, as the third character in the common code at Step 314. If a third sayable is exists, its sayable representative character is entered as the third character of the code at Step 316.

After the user inputs the third character of the code at Step 314 or 316, the present invention determines if the characters of the code thus far entered match the first three characters of multiple expansions at the Duplicate Code Query 320; that is, the sayables of two or more expansions parse to the same three-character code. For example, standard and student parse to the same code—sdx. When a code is determined to be a duplicate, a list of options is displayed at Display Options List 322. Otherwise, the present invention advances to the Desired Expansion Have Suffixes query 326.

In some instances, several expansions parse to the same code. However, for table lookup purposes each expansion must be assigned a unique code in the two-column table at Step 318. Therefore, the present invention provides a method for distinguishing multiple expansions whose sayables parse to the same code. For example, the first letters and sayables for alternate, afternoon, attorney, and autonomy parse to the same code, atn. However, the present invention allows only one expansion to be associated with a given code, thus necessitating a query to the two-column table 318 for each user entry of a code to determine if multiple matches exist at Duplicate Code Query 320.

The present invention distinguishes the duplicate codes in the two-column table 115 in memory 109 in FIG. 1 at Step 318 by appending expansion-IDs to the codes to provide unique codes for each expansion. In one embodiment, the present invention uses numerals as expansion-IDs. The method of the present invention assigns the most commonly used expansions to the code that excludes an expansion-ID. The present invention assigns the second most commonly used expansion to the code supplemented with the expansion-ID 1. Likewise, the present invention assigns the third most commonly used expansion to the code with the expansion-ID 2 and so on. To assist a user in determining the proper expansion-ID associated with a particular expansion, the software supporting the present invention displays an options list box at Display Options List 322. The display occurs in real time, immediately upon detecting a code with multiple expansions. The user either selects the priority expansion (the three-character code) by tapping a delimiter or selects the intended expansion by entering the appropriate expansion-ID (1, 2, 3 . . . or 9) followed by a delimiter at Select Appropriate Expansion 324.

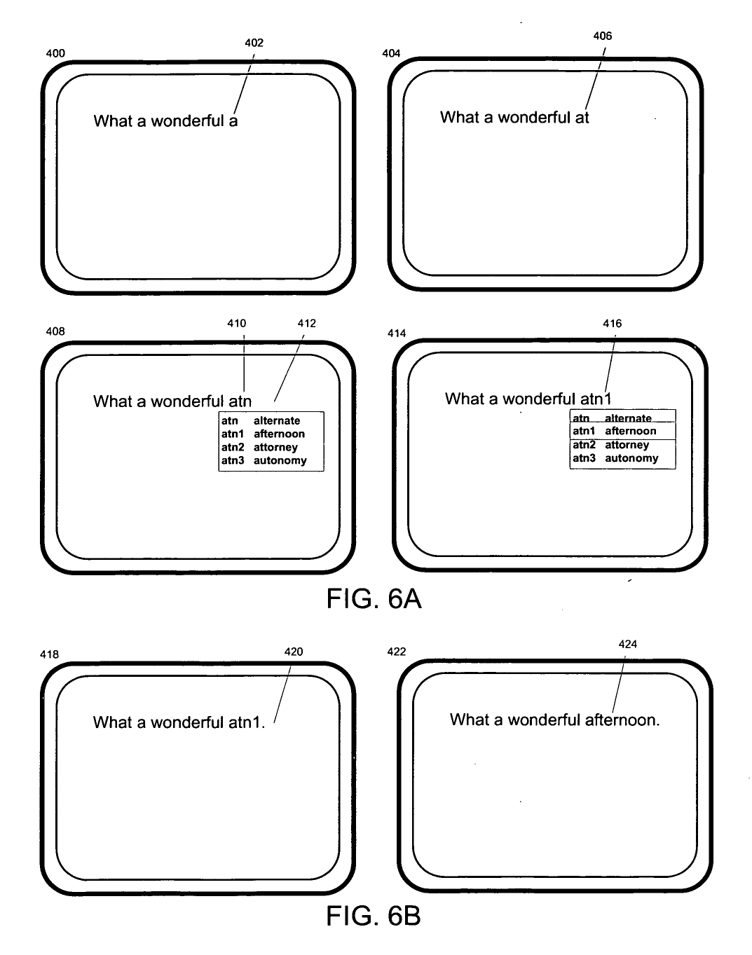

FIG. 6A/6B expands on Steps 322 and 324 in FIG. 5A showing what the user sees and does on a character-by-character basis when entering a code with duplicates in a sentence (atn in the FIG. 6A example). The sequence of display screens in FIG. 6A Steps 400, 404, 408, and 414 demonstrate how a pop-up options list of the present invention prompts the user to select the desired expansion when duplicate codes are encountered during keyboarding. In the example of FIG. 6A the user wishes to key in “What a wonderful afternoon.” Prior to Step 400, the user would have entered wt [What] a wdf [wonderful] a At Step 402, the a being the first character of the code for afternoon (with sayables af-ter-noon and code atn). The user keys in the second character of the code, 1, at Step 406. When the user keys the code's third character, n, at Step 410, the search for a match of the three-character code atn in the two-column table 318 yields four matches (alternate, afternoon, attorney, and autonomy) that are displayed in a pop-up options list at Step 412. In the method of the present invention, the most frequently found expansion is listed with the three-character code and the others are listed in order of frequency of use. The word alternate is entered with the code atn and afternoon, the next most commonly-occurring word, is associated with atn1. In the present invention, the user either enters a delimiter to select the priority option (alternate in the FIG. 6A) or a number 1-9 and then a delimiter to select one of the other options. In the example of FIG. 6A, the user enters the expansion-ID 1 at Step 416 to choose afternoon. At this point a user can opt to enter a suffix-ID at the Desired Expansion Have Suffixes query 326 or proceed to Enter User Entry Delimiter 330 and insert the selected expansion. This process is shown in FIG. 6B where the user enters the delimiter period [.] at Steps 418 and 420 to expand the code to afternoon in Steps 422 and 424.

After the user enters the code or selects the appropriate expansion at Step 322, the present invention's method advances to the Desired Expansion Have Suffixes query 326. At this point the user is given an opportunity to add one or more suffix-IDs to the characters of the code entered thus far. The suffix-IDs listed and illustrated in Table 3 enable rapid entry of expansions that are variations of a root word. For example, the expansion variations (with codes) of the root word separate (spr) are separates (sprs), separated (sprd), separating (sprg), separation (sprn), separations (sprns), separatist (sprt), separatists (sprts), separatism (sprm), separately (spry), separator (sprr), and separators (sprrs).

If the desired expansion requires a suffix at the Desired Expansion Have Suffixes query 326, the present invention progresses to Append Appropriate Suffix-ID 328 so the user can enter one or more suffix-IDs, as needed, before advancing to Enter User Entry Delimiter 330. Otherwise, the user enters a user entry delimiter at Step 330. The present invention compares the code to the codes in the memory-based two-column table 334 to identify a matching code at Compare User Entry to Codes 332. After identifying a matching code, the present invention replaces the user entry on the display with the expansion associated with the matching code at Replaced Code by Desired Expansion 336. The Common Expansion Procedure 300 terminates at End Common Expansion Procedure 338.

The focus of the discussion of the Common Expansion Procedure 300 thus far has been on a negative response to the Word a Prefix query 302. A positive response invokes the present invention's method for handling words with prefixes at Call Prefix Procedure at 304 in FIG. 5A. During the Prefix Procedure 340 illustrated in FIG. 5B, the user enters the prefix-ID as the first character of the user entry at Enter First Character of User Entry as Prefix-ID 342. In one embodiment of the present invention, the universal prefix-ID is q (see Table 5). The user then conceptually removes the prefix from the desired expansion at Step 344 to reveal a root word or its expansion, called a non-prefixed expansion. For example, if the desired word is “interdisciplinary,” the non-prefixed expansion is disciplinary. The user must then identify the sayables and sayable representative characters of the non-prefixed portion of the expansion, di-sci-plinary (code is dsp) at Step 346. After identifying the sayables of the non-prefixed expansion, the user enters the second character of the code as the first character of the non-prefixed portion of the expansion at Step 348. Then third character of the code is entered as the sayable representative character of the second sayable of the non-prefixed portion of the expansion at Step 350. If the non-prefixed expansion does not include a third sayable at Void Sayable Query 352, the user enters the fourth character of the code as the void identifier x at Step 354 and completes the prefix procedure at Step 358. For example, the code for malfunction would be entered as qftx. If the non-prefixed expansion is a three-sayable word at Void Sayable Query 352, the user enters the fourth character of the code as the sayable representative character of the third sayable of the non-prefixed expansion at Step 356 and finishes the prefix procedure at Step 358. For example, the code for interdisciplinary would be entered as qdsp.

Representative entries in the present invention's two-column table that enable users to enter intuitive codes for expansions of thousands of words and phrases are shown in Table 6. The table illustrates two- and three-sayable codes, the handling of duplicate codes, coding for various optional expansions (discussed later), and codes that involve suffix-IDs and/or prefix-IDs.

TABLE 6

| | |
|---|---|
| dcb | December |
| 13t | thirteenth |
| abl | ability |
| abl1 | ambulance |
| abl1s | ambulances |
| abl2 | abolish |
| abl2d | abolished |
| abl2g | abolishing |
| abl2m | abolishment |
| abl2s | abolishes |
| abls | abilities |
| bh | behind |
| bht | bighearted |
| bhv | behavior |
| bhvl | behavioral |
| bhvs | behaviors |
| cvy | clairvoyant |
| cvyc | clairvoyance |
| cwm | chairwoman |
| cwms | chairwomen |
| cwu | Civil War |
| cwx | coward |
| cwxs | cowards |
| cwxy | cowardly |
| cypsq | could you please send me |
| est | essential |
| estq | Eastern Standard Time |
| ests | essentials |
| esty | essentially |
| esvz | El Salvador |
| esvzn | Salvadoran |
| iau | in absentia |
| iawiq | I am writing in regard to |
| mdm | misdemeanor |
| mdm1 | middleman |
| mdm1s | middlemen |
| mdms | misdemeanors |
| mdn | modernize |
| mdnd | modernized |
| mdng | modernizing |
| mdnn | modernization |
| mdns | modernizes |
| mdo | mediocre |
| mdo1 | murderous |
| mdo1y | murderously |
| mdoy | mediocrity |
| mdq | muscular dystrophy |
| qblt | antiballistic |
| qblv | unbelievable |
| qblx | counterbalance |
| qblx1 | unbalanced |
| qblx2 | disbelief |
| qbnx | agribusiness |
| qbog | autobiography |
| qbogr | autobiographer |
| rxq | prescription |
| rxqs | prescriptions |
| ryq | Respectfully yours |
| sms | submission |
| sms1 | salesmanship |
| sms2 | sportsmanship |
| sms3 | statesmanship |
| sms4 | semiskilled |
| wwhal | www.haliburton.com |
| wwhar | www.harley-davidson.com |
| xcm | Christmas |
| xclb | Columbus Day |
| zcnh | Cunningham |
| zmdz | Mendoza |
| zmg | Morgan |
| zmgm | Montgomery |
| zmgr | Margaret |

After the prefix subroutine is terminated, the present invention advances to Duplicate Code Query 320 in FIG. 5A, Common Expansion Procedure 300, and follows the same procedure as describe above for Steps 318-338.

### Optional Expansion Procedures

The Common Expansion Procedure 300 illustrated in FIG. 5A/5B enables very rapid entry of thousands of multiple-syllable words via intuitive codes, but this approach does not apply to the relatively few short words and phrases that comprise over 50% of all the words entered during a typical keyboarding session. Furthermore, the Common Expansion Procedure 300 does not embrace the many other ways intuitive coding can be employed to expand words in a computer application. The present invention takes advantage of these opportunities and describes special rules and circumstances for rapid entry of these high-frequency words, a variety of common phrases, and words within common word categories. The Optional Expansion Procedures 500 described herein and illustrated in FIG. 7A/7B provides users with an opportunity to achieve significantly greater improvements in keyboarding productivity. The productivity tools are presented in three areas: quick entry words (Steps 502-506); phrases, sentences, acronyms and abbreviations (Steps 508-530); and common word categories (Steps 532-574).

### Quick Entry Words

The present invention discloses special rules for quick entry of a group of high-frequency words which can comprise about 35-40% of the words in a typical written communication or document. These words are disclosed within the present invention as quick entry words. For example, but and with are entered with single-character codes and high-frequency prepositions, such as between and around, are assigned two-character codes. When these coded quick entry words are considered with other high-frequency one- or two-character words, such as, of, to, a, in, is, it, on, be, he, as, by, at, and so on, the keyboarder employing the present invention can expect to enter in excess of 50% of all words with either one or two keystrokes at the Quick Entry Word query 502. Most of the remaining words in any form of written communication are entered as codes or expansions according to procedures disclosed by the present invention, or they are less than six letters and entered as they are spelled.

Many of the 200-plus quick entry words in the present invention's two-column table are shown in Table 7. The codes are intuitively constructed for ease of recall at Recall Code 504. With a few exceptions, these simple rules apply when entering codes at Enter Quick Code 506.
Entering short quick entry words. Short, usually single-syllable words, are expanded by entering the first letter of the most commonly used word for a given letter or by the word's first and last letters. For example, the code t expands to the and the code wh expands to which.
Entering multiple-syllable quick entry words. Two-syllable quick entry words are entered according to the rule for two-sayable root words, but without the void identifier. For example, the codes for between, something, and therefore are bt, st, and tf.
Exceptions for quick entry words. Coding overlap dictates the need for several exceptions. The codes for the quick entry words and (n), are (r), you (u), your (uu), and other (o) do not follow the above rules, however, they remain intuitive in structure.
   The codes and expansions in Table 7 are easily learned and remembered in minutes because they are intuitive and occur multiple times in almost every sentence of written communication.

TABLE 7

| Code | Expansion |
|---|---|
| ab | about |
| ac | across |
| ag | against |
| al | along |
| ar | around |
| b | but |
| bf | before |
| bh | behind |
| bl | below |
| bn | beneath |
| bs | beside |
| bt | between |
| c | can |
| cd | could |
| dp | despite |
| ec | except |
| em | e-mail |
| ems | e-mails |
| et | either |
| f | for |
| fm | from |
| h | have |
| hg | having |
| n | and |
| nt | nothing |
| nw | nowhere |
| o | other |
| os | outside |
| ov | over |
| p | please |
| pp | people |
| r | are |
| rl | herself |
| sd | should |
| se | some |
| sh | somehow |
| st | something |
| sw | somewhere |
| t | the |
| te | there |
| tf | therefore |
| tm | them |
| tn | than |
| ts | this |
| tt | that |
| tw | toward |
| ty | they |
| u | you |
| ud | under |
| uo | upon |
| ut | until |
| uu | your |
| vy | very |
| w | with |
| wd | would |
| wi | within |
| wn | when |
| wo | without |
| wt | what |
| wh | which |

Once the one- or two-character quick entry code is keyed in, the user proceeds to Enter User Entry Delimiter 576 in FIG. 7B. The present invention compares the code to the codes in the memory-based two-column table 580 (115 in memory 109 in FIG. 1) to identify a matching code at Compare User Entry to Codes 578. After identifying a matching code, the present invention replaces the code on the display with the expansion associated with the matching code at Step 582. The present invention then terminates Optional Expansion Procedure 500 at Step 584. Steps 576-584 apply to all codes entered for the optional expansion procedures shown in FIG. 7A/7B so this explanation is not repeated in the following discussions.

### Phrases, Sentences, Acronyms and Abbreviations

The present invention discloses a method to permit rapid entry of phrases and sentences, and to expand acronyms to their full-word meaning as part of the Optional Expansion Procedures 500. The method includes procedures and rules presented herein and illustrated in FIG. 7A/7B for expanding phrases/sentences, single-thought word combinations, hyphenated phrases, and acronyms/initialisms.

This capability greatly enhances the productivity potential of the present invention by permitting very rapid entry of common multiple-word phrases and even full sentences. To enable these and other capabilities within the Optional Expansion Procedures 500, the present invention discloses two innovations, the first-ID and the last-ID. The first-ID is a letter or letters with special meaning added at the beginning of a code. The last-ID is a letter or letters with special meaning appended at the end of a code. The first-IDs and the last-IDs add a layer of uniqueness that permits the use of a greater number of short codes that do not conflict with codes for root words and their variations. The codes containing first-IDs and last-IDs offer keyboarding efficiencies that routinely surpass 6 to 1 (6 characters entered with one keystroke).

If a user wishes to use a code to insert an expansion of a common phrase or sentence at the Common Phrase/Sentence query 508, the user inputs the first letters of the first two words (if only two), three words (if only three), or four words of the phrase or sentence and appends the last-ID, a q is one embodiment, to form the code that when entered is expanded to a common phrase or sentence at Step 510. The following are examples of the hundreds of common phrases and sentences that can be expanded with three, four, and five character codes found in the full two-column table of the present invention.

TABLE 8

| | |
|---|---|
| atorq | according to our records |
| bwq | Best wishes |
| eitiq | enclosed is the information you requested |
| ihyhq | I hope you have had a chance to look over the |
| | materials |
| iwcbq | if we can be of assistance, we are at your service |
| psq | paradigm shift |
| ttylq | Talk to you later |
| tyiaq | thank you in advance |
| yclmq | You can learn more about this at |

The present invention discloses a method that permits the keyboarder to enter codes for single-thought word combinations at the Single-Thought Word Combination query 516. A number of word combinations, many of which are commonly used Latin phrases, are stated as a single thought. People often use “bona fide” to refer to something that is genuine in nature or “inside out” to infer thoroughly or back to front. These single-thought word combinations are found in many professions, including medicine (rigor mortis), academe (alma mater and magna cum laude), and law (per stirpes and modus operandi). The codes associated with the single-thought combination expansions are formed by the first letters of the first two words (if only two), three words (if only three), or four words of the combination plus the last-ID at Step 518. One embodiment of the present invention uses the last-ID u, for underscore (an implied connector between the words). Table 9 shows a small sample of the codes and associated expansions for single-thought word combinations in the present invention's two-column table 580.

TABLE 9

| | |
|---|---|
| cbu | carte blanche |
| eou | ex officio |
| fpu | faux pas |
| hcu | habeas corpus |
| mcu | mea culpa |
| ndpu | nom de plume |
| squ | status quo |
| udu | upside down |

The present invention discloses a method that permits the keyboarder to enter codes for hyphenated phrases at the Hyphenated Phrase query at 520. Hyphenated word combinations, such as goal-oriented or ready-to-use, are common occurrences in written communication. The codes associated with the hyphenated word combination expansions are formed by the first letters of the first two words (if only two), three words (if only three), or four words of the combination plus the last-ID h, for hyphen, at Step 522. Table 10 shows a small sample of the hundreds of codes and associated expansions for hyphenated word combinations in the present invention's two-column table 580.

TABLE 10

| | |
|---|---|
| aah | African-American |
| bmh | computer-generated |
| boh | business-oriented |
| hglh | happy-go-lucky |
| kbh | knowledge-based |
| crh | cross-reference |
| milh | mother-in-law |
| dmh | decision-making |
| utdh | up-to-date |

The present invention discloses a method that permits the keyboarder to enter codes for expanding an acronym or initialism to its full meaning at the Acronym or Initialism query 524. The codes entered to expand acronyms and initialisms are formed by the appending the last-ID q to the acronym or initialism at Step 526. It is common to include both an acronym and its expansion or initialism and its expansion in written communication (e.g., CEO and chief executive officer or LAN and local area network). Table 11 shows a sample of the many common acronyms and initialisms included in the present invention's two-column table.

TABLE 11

| | |
|---|---|
| aarpq | American Association of Retired Persons |
| cooq | chief operating officer |
| dnaq | DeoxyriboNucleic Acid |
| faaq | Federal Aviation Administration |
| gpsq | global positioning system |
| lanq | local area network |
| ngoq | non-government organization |
| pdaq | personal digital assistant |
| roiq | return on investment |
| usptoq | United States Patent and Trademark Office |
| vpnq | virtual private network |

For decades keyboarders have saved keystrokes in informal communications by using shorthand abbreviations for certain common words, such as cross-reference (xref) and duplicate (dup). The present invention provides a method that enables the expansion of these time-honored shorthand abbreviations to the full text of the word(s) for which the abbreviation stands at the Shorthand Abbreviation query 528. The codes entered to expand a shorthand abbreviation are formed by the appending the last-ID q to the abbreviation at the Shorthand Abbreviation query 530. Table 12 shows a sample of the many common shorthand abbreviations included in the present invention's two-column table.

TABLE 12

| | | | |
|---|---|---|---|
| asscq | association | mq | million |
| auxq | auxiliary | mgtq | management |
| avgq | average | mgrq | manager |
| gq | billion | miscq | miscellaneous |
| bldgq | building | modq | modification |
| chgq | change | natlq | national |
| ckq | check | objq | objective |
| xrefq | cross-reference | ptq | point |
| dbq | database | preqq | prerequisite |
| delq | delete | qtyq | quantity |
| deptq | department | rxq | prescription |
| dupq | duplicate | srq | senior |
| fltq | flight | specq | specification |
| govtq | government | stdq | standard |
| gradq | graduate | statq | statistic |
| hwyq | highway | tq | trillion |
| infoq | information | tempq | temperature |
| intlq | international | univq | university |
| kq | thousand | vetq | veteran |

### Common Word Categories

Embodied in the optional expansion procedures of the present invention are rules for entering codes for rapid expansion of members of a variety of word groups. The present invention discloses procedures and rules presented herein and illustrated in FIG. 7A/7B for creating and expanding codes for proper names, names of geographical locations, numbers, days, months, keyboard key names, current date/time, and holiday names.

The present invention discloses a method that permits the keyboarder to enter codes for expanding most first names or common last names at the Name query 532. The present invention rule for forming name codes at Step 534 is as follows: [first-ID z, the name identifier] [1^{st} letter] [sayable representative character of 2^{nd} sayable, if 2-sayable name] [sayable representative character of 3^{rd} sayable, if 3-sayable name]. For example, Patrick Richardson is expanded by keying zpt zrcs. Table 13 contains a few of the hundreds of names found in the full two-column table of the present invention that can be expanded with two, three, and four character codes.

TABLE 13

| | | | |
|---|---|---|---|
| zbbr | Barbara | zctp | Christopher |
| zelz | Elizabeth | zjnt | Jonathan |
| zspn | Stephanie | zjs | Joseph |
| zptc | Patricia | zmt | Matthew |
| zs | Smith | zas | Armstrong |
| zads | Anderson | zzmm | Zimmerman |

The present invention discloses a method that permits the keyboarder to enter codes for expanding a state name at the query 536. The present invention rule for forming state name codes at Step 538 is as follows: [standard 2-character postal code abbreviation] [last-ID z, the geographic identifier]. For example, the user keys the code msz to be expanded to Mississippi. Table 14 contains examples of the complete list of state/territory names found in the full two-column table 580 of the present invention. Note that a z at the beginning of a code denotes a name identifier and at the end of code, a z denotes a geographic identifier.

TABLE 14

| | | |
|---|---|---|
| akz | AK | Alaska |
| alz | AL | Alabama |
| caz | CA | California |
| coz | CO | Colorado |
| ctz | CT | Connecticut |
| dcz | DC | District of Columbia |
| gaz | GA | Georgia |
| hiz | HI | Hawaii |
| ilz | IL | Illinois |
| inz | IN | Indiana |
| laz | LA | Louisiana |
| maz | MA | Massachusetts |
| mdz | MD | Maryland |
| mnz | MN | Minnesota |
| moz | MO | Missouri |
| mtz | MT | Montana |
| ncz | NC | North Carolina |
| nhz | NH | New Hampshire |
| njz | NJ | New Jersey |
| nmz | NM | New Mexico |
| nvz | NV | Nevada |
| okz | OK | Oklahoma |
| orz | OR | Oregon |
| scz | SC | South Carolina |
| sdz | SD | South Dakota |
| utz | UT | Utah |
| vaz | VA | Virginia |
| vtz | VT | Vermont |
| wvz | WV | West Virginia |
| wyz | WY | Wyoming |

The present invention discloses a method that permits the keyboarder to enter codes for expanding geographic locations and sites other than states at the Non-State Geographic Location query 540. If the user is entering a non-state geographic location at Step 542, the characters in the codes are determined as you would for any root word, except that the sayables can span two or more words. For example, Los Angeles has three sayables, one in the first word and two in the second. The present invention rule for forming codes for names of non-state geographic locations at Step 542 is as follows: [1^{st} letter] [sayable representative character of 2^{nd} sayable of the combined words, if 2^{nd} sayable exists] [sayable representative character of 3^{rd} sayable of the combined words, if 3^{rd} sayable exist] [last-ID z, the geographic identifier]. Table 15 contains examples of the complete list of non-state names of hundreds of geographic locations found in the full two-column table of the present invention.

TABLE 15

| | |
|---|---|
| gz | Greece |
| ldz | London |
| lagz | Los Angeles |
| ntlz | Netherlands |
| nolz | New Orleans |
| rkmz | Rocky Mountains |
| slkz | Sri Lanka |
| untz | United States of America |
| ylsz | Yellowstone National Park |

If the user is entering a demonym or name of inhabitant(s) at Step 544, the user appends the suffix-ID n to the state or country code at Step 546 (most demonyms end with the suffix an). The plural suffix-ID s is appended to the state or country code to refer to more than one person. Table 16 contains examples from the list of demonyms or name of inhabitant(s) of states and countries found in the two-column table of the present invention.

TABLE 16

| | | | | | |
|---|---|---|---|---|---|
| amrz | America | amrzn | American | amrzs | Americans |
| cndz | Canada | cndzn | Canadian | cndzs | Canadians |
| lebz | Luxembourg | lebzn | Luxembourger | lebzs | Luxembourgers |
| mlsz | Malaysia | mlszn | Malaysian | mlszs | Malaysians |
| arz | Arkansas | arzn | Arkansan | arzs | Arkansans |

The present invention discloses a method that permits the keyboarder to enter codes for expanding numbers and positions at the Number or Position query 552. The present invention allows a number to be expanded at Step 554 into the spelled-out number (two), the multiple (twice), the order (secondary), the ordinal (second), and the decade (twenties) by appending intuitive last-IDs to the number. In one embodiment of the present invention, the intuitive last-IDs for the various options are q for spelled-out number, x for the multiple, y for the order, t for ordinal, and s for decades. The Tables 17-21 show the present invention's two-column table entries for one embodiment of number-related codes and expansions.

TABLE 17

| | |
|---|---|
| 0q | zero |
| 1q | one |
| 2q | two |
| 3q | three |
| 4q | four |
| 5q | five |
| 6q | six |
| 7q | seven |
| 8q | eight |
| 9q | nine |
| 10q | ten |
| 11q | eleven |
| 12q | twelve |
| 13q | thirteen |
| 14q | fourteen |
| 15q | fifteen |
| 16q | sixteen |
| 17q | seventeen |
| 18q | eighteen |
| 19q | nineteen |
| 20q | twenty |
| 30q | thirty |
| 40q | forty |
| 50q | fifty |
| 60q | sixty |
| 70q | seventy |
| 80q | eighty |
| 90q | ninety |
| 100q | hundred |
| 1000q | thousand |

TABLE 18

| | |
|---|---|
| single | 1x |
| double | 2x |
| triple | 3x |
| quadruple | 4x |

TABLE 19

| | |
|---|---|
| primary | 1y |
| secondary | 2y |
| tertiary | 3y |

TABLE 20

| | |
|---|---|
| first | 1t |
| second | 2t |
| third | 3t |
| fourth | 4t |
| fifth | 5t |
| sixth | 6t |
| seventh | 7t |
| eighth | 8t |
| ninth | 9t |
| tenth | 10t |
| eleventh | 11t |
| twelfth | 12t |
| thirteenth | 13t |
| fourteenth | 14t |
| fifteenth | 15t |
| sixteenth | 16t |
| seventeenth | 17t |
| eighteenth | 18t |
| nineteenth | 19t |
| twentieth | 20t |
| thirtieth | 30t |
| fortieth | 40t |
| fiftieth | 50t |
| sixtieth | 60t |
| seventieth | 70t |
| eightieth | 80t |
| ninetieth | 90t |
| hundredth | 100t |
| thousandth | 1000t |

TABLE 21

| | |
|---|---|
| twenties | 2s |
| thirties | 3s |
| forties | 4s |
| fifties | 5s |
| sixties | 6s |
| seventies | 7s |
| eighties | 8s |
| nineties | 9s |

The present invention discloses a method that permits the keyboarder to enter codes for expanding all days of the week and the months at the Day query 556 and the Month query 560. The present invention assigns unique intuitive codes as shown in Table 22 for expansion of days at Steps 558. The codes for months as shown in Table 23 at Step 562 by this rule:] [1^{st} letter] [sayable representative character of 2^{nd} sayable, if 2-sayable month] [sayable representative character of 3^{rd} sayable, if 3-sayable month].

TABLE 22

| | |
|---|---|
| mdy | Monday |
| tdy | Tuesday |
| wdy | Wednesday |
| thdy | Thursday |
| fdy | Friday |
| sdy | Saturday |
| sudy | Sunday |

TABLE 23

| | |
|---|---|
| jua | January |
| fba | February |
| m | March |
| ap | April |
| j | June |
| jl | July |
| ag | August |
| stb | September |
| otb | October |
| nvb | November |
| dcb | December |

The present invention discloses a method that permits the keyboarder to insert the name of a non-alpha keyboard key at the Keyboard Key Name query 564. To do so the user taps the desired key and the last-ID q at Step 566. For example, the user entry ?q inserts the expansion question mark. Table 24 shows a few of the present invention's complete set of entries for expanding the names of keyboard keys found in the two-column table. The names of the numbers keys are entered in a similar manner (see Table 18).

TABLE 24

| | |
|---|---|
| (q | parentheses |
| *q | asterisk |
| >q | greater than |
| /q | forward slash |
| !q | exclamation point |

The present invention discloses a method that permits the keyboarder to insert the current Date and/or Time at query 568. To do so, the user inputs the current date identifier, the current time identifier, and/or the current date and time identifier at Step 570. The present invention extracts the requested information from the operating system's clock/calendar and replaces the identifier with the current date, time, or both. In one embodiment of the present invention, the user enters the code $d to insert the current date, $t to insert the current time, and $dt to insert current date and time.

The present invention discloses a method that permits the keyboarder to enter codes for expanding names of holidays at the Holiday query 572. The code for the expansions for the holidays is composed of the first-ID x, the holiday identifier, plus the sayable representative characters of up to three sayables of the combined words. The present invention rule for forming codes for holiday names at Step 572 is as follows: [first-ID z, the holiday identifier] [1^{st} letter] [sayable representative character of 2^{nd} sayable of the combined words, if 2^{nd} sayable exists] [sayable representative character of 3^{rd} sayable of the combined words, if 3^{rd} sayable exist]. For example, entering code xmtd expands to Mother's Day. Table 25 shows a few the present invention's complete set of entries for expanding holidays found in the two-column table.

TABLE 25

| | |
|---|---|
| xafc | Armed Forces Day |
| xawd | Ash Wednesday |
| xccd | Cinco de Mayo |
| xcm | Christmas |
| xet | Easter |
| xfd | Flag Day |
| xhlw | Halloween |
| xhnk | Hanukkah |
| xidp | Independence Day |
| xkz | Kwanzaa |
| xlbd | Labor Day |
| xlla | Laylat Al-Isra wa Al-Miraj |
| xmhr | Muharram |
| xmtd | Mother's Day |
| xmtl | Martin Luther King Day |
| xnyd | New Year's Day |
| xpov | Passover |
| xpsd | Presidents' Day |
| xrhs | Rosh Hashanah |
| xrmd | Ramadan |
| xspt | St. Patrick's Day |
| xtgv | Thanksgiving Day |
| xvlt | Valentines Day |
| xykp | Yom Kippur |

### Custom Expansion Procedures

The present invention's system for intuitive coding to enter text expansions facilitates rapid entry of words and terms, abbreviations and acronyms, phrases and sentences, and text by category (addresses, boilerplate, and so on) that are peculiar to a specific industry, profession, family, individual, or any other unique keyboarding environment. The present invention allows a user to create a custom two-column table for their own purposes. The custom code/expansion entries to the two-column table in support of customization are created and posted to the table by the user (or possibly at the corporate level) according to the rules set forth in earlier sections, but with one exception. That is, the last-ID custom identifier, aj for one embodiment, denotes that the code is intended for a custom expansion. The custom codes and expansions reside in memory 109 in the two-column table 115. The use of the custom identifier increases the number of possible codes and allows a user to create user-defined codes that do not conflict with codes employed in the Common Expansion Procedure 300 or the Optional Expansion Procedures 500. The effective use of custom codes and expansions can significantly boost keyboarding productivity because custom codes often expand to large numbers of characters (e.g., boilerplate, addresses, directions, department names, and so on). The Custom Expansion Procedure 600 and its four components are illustrated in FIG. 8 and presented below for custom user entries to be entered to an application for expansion at Step 602.

Custom Words and their Variations

The present invention invites keyboarders to associate custom words and terms to their expansions for inclusion in the two-column table 630. Coding of custom legal, medical, or other industry-related words and terms follows the same rules as coding for the present invention's root words (306-324 in FIG. 5A) except the code is terminated with the last-IDj, the custom identifier. For example, in a medical clinic or hospital the term gastrointestinal might be coded as gtq. Entering simply gti (without the last-IDj) inserts the word root word gratuity. The custom codes for three-plus sayable words are formed at Step 608 using this rule:
Custom Code₃=[1^{st} letter] [sayable representative character of 2^{nd} sayable] [sayable representative character of 3^{rd} sayable]j

Codes for two-sayable custom words are formed in a like manner except the code's third character is x, the void identifier. For example, in legal practice, the custom term bailment might code to bmxj. Entering simply bmx (without the last-IDj) inserts the word root word benchmark. If the custom word is a variation at Step 606, prefix-IDs and suffix-IDs are appended to custom words in the same manner as they are to root words (326-326 in FIG. 5A) to form variations of a custom word at Step 610. For example, the plural of bailments, would be entered as bmxjs. The rule for duplicate common codes is applicable to custom codes and expansions, as well.

Once the custom code is keyed in, the user proceeds to Enter User Entry Delimiter 626. The present invention compares the code to the codes in the memory-based two-column table 630 (115 in memory 109 in FIG. 1) to identify a matching code at Compare User Entry to Codes 628. After identifying a matching code, the present invention replaces the custom code on the display with the expansion associated with the matching code at Replace Code by Desired Expansion 632. The present invention then terminates custom expansion procedure at End Custom Expansion Procedures 634. Steps 626-634 apply to all codes entered for the Custom Expansion Procedure 600 shown in FIG. 8 so this paragraph is not repeated in the following discussions.

### Custom Acronyms, Initialisms, and Abbreviations

Every business has a plethora of business and/or industry-specific acronyms, in'initialisms, and abbreviations that could be coded for the two-column table 630 and expanded via the present invention's system of rules at Step 612. Use the same rules for creating codes for these as described in Steps 524-530, but add the last-IDj to create the code for custom acronyms, initialisms, and abbreviations. For example, an accounting office might add the acronym VAT (value added tax), the initialism TCO (total cost of ownership), and the abbreviation pubs (publications) to their custom two-column table. Having done so, they might enter vatj to insert value added tax, tcoj to insert total cost of ownership, and pubsj to insert publications at Step 614.

### Custom Phrases or Sentences

The present invention enables custom phrases and sentences to be added to the two-column table 630 and recalled in the same manner as common phrases and sentences in Steps 508-510, except the last-IDj, the custom identifier, is appended to the code instead of a q. For custom phrases and sentences at Step 616, the method of present invention is to form the code by entering the first letters of two, three, or four words, as applicable, and then complete the code with the last-IDj at Step 618. For example, the custom phrase power of attorney is associated with the code poaj and alternative dispute resolution is adrj. The sentence “If we proceed with additional work relating to this matter or an unrelated matter, we may require an additional retainer.” is given the code iwpwj, the first letters of the first four words plus the last-IDj.

### Custom Text by Category

In the business world, several categories of text information appear frequently in written communication (for example, telephone numbers and e-mail addresses). The present invention permits custom coding of this information by category to enable easy expansion within any application. The categories to be expanded at Custom Text by Category 620 include addresses, boilerplate, credit card numbers, directions, e-mail addresses, names, passwords, usernames, signatures, telephone numbers, and website URLs. In the method of the present invention, the custom code is constructed at Step 622 and 624 by combining an intuitive double letter first-ID, the category identifier, with a unique information identifier to form the codes for custom entries in each of these 11 categories. For example, keying the custom category code alone might insert the mailing address (aa portion of code) for Long & Associates (long portion of code). Table 26 summarizes the custom coding method for the 11 custom text categories of the present invention and presents examples of each.

TABLE 26

| | Double | | Example | |
|---|---|---|---|---|
| | letter | Unique | custom | |
| | category | information | category | |
| Category | identifier | identifier | code | Example expansion |
| Addresses | aa | Company: up to | aacono | ConocoPhillips |
| | | four letters of the | | 600 N. Dairy Ashford |
| | | company name or | | Rd. |
| | | the complete | | Houston, TX 77079 |
| | | abbreviation | | |
| | | Individual: first | aatbar | Troy Barrentine |
| | | letter of first name | | 426 Maple Street, Apt. A |
| | | and the first three | | Bethlehem, PA 18015 |
| | | letters of the last | | |
| | | name | | |
| Boilerplate | bb | A user-defined | bbclose | Please review this |
| text | | descriptive | | letter, sign on the line |
| | | word/code that | | below, and return to |
| | | identifies the | | our office. If you have |
| | | boilerplate phrase, | | any questions, I am at |
| | | sentence(s), or | | your service. |
| | | paragraph(s) | | |
| Credit | cc | A descriptive | cccorpae | 5566-1122-8899-3344 |
| card | | word/code that | (corporate | |
| numbers | | identifies the credit | American | |
| | | card | Express) | |
| Directions | dd | Same as address | ddlong | Navigate to Hwys 45 |
| | | above for a | (directions to | and 265. Go east 1 mi. |
| | | company or | Long & | on 45, turn right on |
| | | individual | Associates) | Starr Dr., and go |
| | | | | straight into the |
| | | | | company gate. |
| | | | ddjste | Take Exit 68 off I-540 |
| | | | (directions to | and go east exactly 2 |
| | | | the home of | miles. Enter the Clear |
| | | | James | Oaks subdivision. It's |
| | | | Stephens) | the fourth home on the |
| | | | | left. |
| E-mail | ee | Same as address | eerbar | rbarthel@sbcglobal.net |
| addresses | | above for | (e-mail for | |
| | | individual | Robert | |
| | | | Barthel) | |
| Names | nn | Same as address | nnmcgr | McGraw-Hill, Inc. |
| | | above for a | nnphol | Patricia Holdorf |
| | | company or | | |
| | | individual | | |
| Passwords | pp | First three letters of | ppyah | salesqueen#1227 |
| | | domain name | (Yahoo | |
| | | | password) | |
| Usernames | uu | First three letters of | uugoo | jenniferchristenson |
| | | domain name | (google | |
| | | | username) | |
| Signatures | ss | Same as e-mail, but | ssnpolb | Nancy Pollard, Ph.D. |
| | | add b for business, | (business | Communications |
| | | h for home, and l | signature for | Express, Ltd. |
| | | for leisure | Nancy | 8200 Tournament Dr. |
| | | | Pollard) | Memphis, TN 38125 |
| Telephone | tt | same as e-mail, but | ttsleoc | 251-555-1909 |
| numbers | | add b for business, | (Stanley | |
| | | h for home, and c | Leonard cell | |
| | | for cellular | phone) | |
| Website | ww | First three letters of | wwwea | www.weather.com |
| URL | | domain name | (weather.com) | |

Table 27 shows a variety of custom codes and expansions that might be created for the custom portion of the two-column table by users in a medical clinic.

TABLE 27

| | |
|---|---|
| aablue | BlueCross BlueShield of Minnesota |
| | Health Plaza East |
| | 1303 Corporate Center Drive |
| | Eagan, MN 55121-1204 |
| dnaj | deoxyribonucleic acid |
| eejrot | jonathanrothlisberger@washingtonregional.org |
| ekgj | electrocardiogram |
| emuj | epilepsy monitoring unit |
| espj | esophagogastroduodenoscopy |
| gcj | gastrointestinal consultation |
| hrtj | hormone replacement therapy |
| tpdaj | The patient demonstrates an understanding of the risks |
| | associated with the proposed surgical procedure. |
| wwwas | www.washingtonregional.org |

### Internet or Help Procedure

The present invention extends keyboarding productivity to include direct interaction with a web browser, all within the context of entering text into an application. This capability and the help procedure are illustrated in FIG. 9 Internet or Help Procedure 700. If a keyboarder wishes to open the default web browser to a specific Internet address at the Open Browser to a Website query 702, the user enters the code for that address at Step 704. The code is the browser identifier, www in one embodiment, plus the first three letters of the domain name. Codes and expansions for the most popular domain names are included in the present invention's two-column table 115 in memory 109. For example, after entering wwwsen and a delimiter, an association is made to the website www.senate.gov at Identify Matching Code 706 by comparing the user entry to the codes in the two-column table. The present invention then opens the default browser to the website associated with the matching code at Open Step 708.

The present invention expedites Internet searches by permitting the user to select a search provider and enter a search string while entering text within an application. For example, a user may wish to perform a search on a particular topic that is related to the content of the user's text session at the Open Browser and Display Search Results query 710. The present invention allows a user to open a web browser to one of the popular search providers and perform a search on the search string embedded in the in-line user entry. To accomplish an in-line search query, the user inputs a user entry that identifies the desired search provider, such as Yahoo or Wikipedia, and the search string which is denoted by the open/close query identifier (double forward slashes) at Step 712. For example, for the user entry wwwyah//patents and trademarks// the present invention opens the default browser and performs the designated search at Perform Search 714 and displays the search results within yahoo.com for the search string “patents and trademarks” at Display Results of Search Query 716. The quick Internet search text is removed from the document when the browser opens. The present invention's method is to initiate the search using the appropriate search syntax for the desired search provider and search string.

If a user desires assistance with the use of the present invention at Help query 718, the user enters either h to open the main Help menu or the first letter of the desired main Help menu item within the open/close double backward slashes, the help identifier in one embodiment, at Step 720. The present invention then displays the Help menu at Display Help Menu 722.

If in the course of keyboarding a user is not able to determine or recall a code for a particular expansion at Code Lookup query 724, the user enters the desired expansion to search for its code by using the help identifiers at Step 726. The user enters the expansion between the begin/end help identifiers. For example, to look up the code for the word mischievously, enter mischievously. Upon tapping a delimiter key, the present invention compares the expansion to the expansions stored in the two-column table to identify a matching expansion at Step 728. Once a match is found, the user entry is deleted and the present invention displays the code associated with the matching expansion at Step 730, mcvy in the example. Web browser, help, in-line search, and code lookup processes terminate at Internet or Help Procedure 732.

From the foregoing, it will be seen that the present invention is one well adapted to obtain all the ends and objects herein set forth, together with other advantages which are inherent to the structure.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

What is claimed is:

1. A method for automatically expanding a user entry, said method comprising:
receiving a user entry of at least one character;
identifying a user entry delimiter that indicates that the user entry has been entered;
associating at least one code with at least one expansion, the code including at least one character, the expansion including at least one character, segmenting the expansion into at least one sayable, each sayable including at least one character forming distinctly separate sounds in the expansion when the expansion is spoken or uttered with a natural cadence, inflection, and rhythm, assigning the first character of the code to the first character of the expansion, assigning any subsequent character of the code to the sayable representative character of the corresponding subsequent sayable of the expansion, the sayable representative character typically being the first character of the at least one character forming the dominant sound at the start of the sayable;
comparing the user entry to the at least one code to identify a matching code; and
replacing the user entry with the expansion associated with the matching code.

2. The method of claim 1 further comprising:
associating the code with the expansion according to the probability that the expansion should replace the user entry.

3. The method of claim 2 further comprising:
comparing the first three characters of a user entry to the codes;
identifying multiple matching codes in which the first three characters of the codes equal the first three characters of the user entry;
displaying the expansions associated with the multiple matching codes; and
allowing the user the user to select an expansion.

4. The method of claim 3 further comprising:
distinguishing the multiple matching codes by including an expansion identifier in each of the multiple matching codes.

5. The method of claim 1 wherein the user entry delimiter is a space character, an enter character, a punctuation character, or a non-alphanumeric character.

6. The method of claim 1, wherein the expansion comprises a plurality of characters that is not limited to a single word.

7. The method of claim 1 further comprising:
enabling the user to associate a user defined code with a user defined expansion.

8. The method of claim 1 further comprising:
detecting a begin search parameters delimiter in the user entry;
detecting an end search parameters delimiter in the user entry;
parsing the characters between the begin search query delimiter and the end search query delimiter to identify at least one search parameter;
creating a search query from the at least one search parameter; and
opening a web browser to display the results of the search query.

9. The method of claim 1 further comprising:
detecting a begin expansion delimiter in the user entry;
detecting an end expansion delimiter in the user entry;
parsing the characters between the begin expansion delimiter and the end expansion delimiter to identify an expansion lookup;
comparing the expansion lookup to an expansion to identify at least one matching expansion; and
displaying the code associated with the at least one matching expansion.

10. The method of claim 1 further comprising:
associating at least one common expansion to a code of one character.

11. A method for automatically expanding a user entry, said method comprising:
receiving a user entry of at least one character;
identifying a user entry delimiter that indicates that the user entry has been entered;
associating at least one code with at least one expansion, the code including at least one character, the expansion including at least one character, segmenting the expansion into at least one sayable, each sayable including at least one character forming distinctly separate sounds in the expansion when the expansion is spoken or uttered with a natural cadence, inflection, and rhythm, assigning the first character of the code to the first character of the expansion, assigning any subsequent character of the code to the sayable representative character of the corresponding subsequent sayable of the expansion, the sayable representative character typically being the first character of the at least one character forming the dominant sound at the start of the sayable, associating the code with the expansion according to the probability that the expansion replaces the user entry;
comparing the user entry to the at least one code to identify a matching code; and
replacing the user entry with the expansion associated with the matching code.

12. The method of claim 11 further comprising:
comparing the first three characters of a user entry to the codes;
identifying multiple matching codes in which the first three characters of the codes equal the first three characters of the user entry;
displaying the expansions associated with the multiple matching codes; and
allowing the user the user to select an expansion.

13. The method of claim 12 further comprising:
distinguishing the multiple codes by including an expansion identifier in each of the multiple codes.

14. The method of claim 11 further comprising:
enabling the user to create a customized code associated with a customized expansion.

15. The method of claim 11 further comprising:
detecting a begin search parameters delimiter in the user entry;
detecting an end search parameters delimiter in the user entry;
parsing the characters between the begin search query delimiter and the end search query delimiter to identify at least one search parameter;
creating a search query from the at least one search parameter; and
opening a web browser to display the results of the search query.

16. The method of claim 11 further comprising:
associating at least one common expansion to a code of one character.

17. A method for associating a code with an expansion for automatic expansion of text:
parsing a root word to identify at least two sayables, said sayables including at least one character forming distinctly separate sounds in the root word when the root word is spoken with a natural cadence, inflection, and rhythm;
associating the first character of the root word code to the first character of the root word;
associating the second character of the root word code to the sayable representative character of the second sayable of the root word, the sayable representative character being the first character of the at least one character forming the dominant sound at the start of sayable except when the first character of the sayable produces a silent sound.

18. The method of claim 17 further comprising:
associating the third character of the root word code with the sayable representative of the third sayable or a void identifier; associating the third character of the root word code with the sayable representative character of the third sayable if the root word includes a third sayable; associating the third character of the root word code to a void sayable identifier if the root word does not include a third sayable.

19. The method of claim 18 further comprising:
identifying at least one prefix of the expansion; and
appending at least one prefix identifier to the root word code to form the code.

20. The method of claim 18 further comprising:
identifying at least one suffix of the expansion; and
appending at least one suffix identifier to the root word code to form the code.
